(19) United States
(12) Patent Application Publication
(10) Pub. No.: US 2023/0240368 A1
(43) Pub. Date: Aug. 3, 2023

(54) HEATING ASSEMBLY, ATOMIZER, MANUFACTURING METHOD OF HEATING ASSEMBLY, AND ASSEMBLY METHOD OF ATOMIZER

(71) Applicant: Smiss Technology Co., Ltd., Shenzhen (CN)

(72) Inventor: Jiatai Chen, Irvine, CA (US)

(73) Assignee: Smiss Technology Co., Ltd., Shenzhen (CN)

(21) Appl. No.: 18/157,084

(22) Filed: Jan. 20, 2023

Related U.S. Application Data
(60) Provisional application No. 63/304,624, filed on Jan. 30, 2022.

(30) Foreign Application Priority Data
Mar. 24, 2022 (CN) 202210296451.9
Mar. 24, 2022 (CN) 202220659265.2
May 9, 2022 (CN) 202210499958.4
May 9, 2022 (CN) 202210499959.9
May 9, 2022 (CN) 202210499961.6
May 9, 2022 (CN) 202221099745.4

(51) Int. Cl. A24F 40/46; H05B 3/28; H05B 3/06; A24F 40/10; B29C 45/14; A24F 40/70; A24F 40/485

(52) U.S. Cl. CPC A24F 40/46; A24F 40/10; A24F 40/70; A24F 40/485; B29C 45/14; H05B 3/06; H05B 3/28; B29L 2031/7414; H05B 2203/016; H05B 2203/017

(57) ABSTRACT

A heating assembly includes an atomizing base and a resistive heating element at least partially embedded in the atomizing base. The resistive heating element includes a heating fence, two connecting portions and two conductive pins arranged along a length direction of the resistive heating element. The heating fence is located in a middle of the resistive heating element. The two connecting portions are respectively located on two opposite sides of the heating fence and are interconnected by the heating fence. The two conductive pins are located at two opposite ends of the resistive heating element and are connected with the two connecting portions respectively. The atomizing base includes a base plate and a side wall extending from a periphery of the base plate. A receiving cavity is formed in the atomizing base. An atomizing opening penetrates through the base plate. The atomizing opening is aligned with the heating fence.

### CROSS REFERENCE TO RELATED APPLICATIONS

The present disclosure is based on and claims priority to U.S. Provisional Pat. Application No. 63/304,624, filed on Jan. 30, 2022, and claims priority to Chinese Patent Application Nos. 202210296451.9 and 202220659265.2, both of which are filed on Mar. 24, 2022, and claims priority to Chinese Patent Application Nos. 202210499959.9 and 202221099745.4, both of which are filed on May 09, 2022, and further claims priority to Chinese Patent Application Nos. 202210499958.4 and 202210499961.6, both of which are filed on May 09, 2022. The entire contents of the above-identified applications are incorporated herein by reference.

### TECHNICAL FIELD

The present disclosure relates to the technical field of electronic atomization, and in particular, to a heating assembly, an atomizer, a manufacturing method of a heating assembly and an assembly method of an atomizer.

### BACKGROUND

Atomizer is the core part of electronic atomization products. The quality reliability of the atomizer determines the quality of the whole atomization product.

One of the existing atomizing structures is: the surface of ceramic porous material is printed and covered with heating slurry or the surface is embedded with metal resistive heating body. In both methods, porous ceramics are used as the oil conducting material to absorb smoke oil to the surface of the resistive heating body, which generates heat when the resistive heating body is energized, so as to atomize the smoke oil. The atomizing structures made by these methods have complex ceramic molding process, low yield and poor consistency of ceramics, so they have the disadvantages of high product cost, slightly poor oil conductivity of ceramics to easily produce burning smell, and slightly poor taste reduction.

Another existing atomizing structure is: the surface of a transverse cotton core is wrapped with a spiral resistive heating wire, the transverse cotton core absorbs the smoke oil to the surface of the resistive heating wire, and generates heat when the resistive heating wire is energized, so as to atomize the smoke oil. The transverse cotton core of the atomizing structure in this way is very easy to deform, resulting in difficult assembly, and the long oil guide distance is easy to produce burning smell.

A further existing atomizing structure is: the external surface of the resistive heating body of a vertical cotton core is wrapped with oil guide cotton, and the internal side of the resistive heating body is hollow. The oil guide cotton wrapped on the surface absorbs the smoke oil to the surface of the resistive heating body, and generates heat when the resistive heating body is energized, so as to atomize the smoke oil. The vertical cotton core of the atomizing structure in this way consists of many parts with complex assembly, resulting in high product cost.

From above, the manufacturing process of the existing atomizing structures is troublesome, with high manufacturing cost and low production efficiency, which cannot meet the requirements of the stability of product quality and automatic production.

### SUMMARY

In view of the above, the object of the present disclosure is to provide a heating assembly, an atomizer, a manufacturing method of a heating assembly and an assembly method of an atomizer, with high quality stability and capable of automatic production and assembly, so as to at least partially solve the problems of poor consistency of product quality, difficult assembly and high manufacturing cost.

An embodiment of the present disclosure provides a heating assembly. The heating assembly includes an atomizing base and a resistive heating element at least partially embedded in the atomizing base;
wherein the resistive heating element includes a heating fence, two connecting portions and two conductive pins arranged along a length direction of the resistive heating element, the heating fence is located in a middle of the resistive heating element, a plurality of through holes are provided through the heating fence, the two connecting portions are respectively located on two opposite sides of the heating fence and are interconnected by the heating fence, the two conductive pins are located at two opposite ends of the resistive heating element and are connected with the two connecting portions respectively;
wherein the atomizing base includes a base plate and a side wall extending from a periphery of the base plate, a receiving cavity is formed in the atomizing base and enclosed by the base plate and the side wall, an atomizing opening penetrates through the base plate, the atomizing opening is aligned with the heating fence.

An embodiment of the present disclosure further provides an atomizer. The atomizer includes the heating assembly as described above and an oil guiding member received in the atomizing base and in contact with the resistive heating element and the base plate.

An embodiment of the present disclosure further provides a manufacturing method of a heating assembly. The manufacturing method includes:
providing a resistive heating element, wherein the resistive heating element is in the form of a metal sheet, the resistive heating element includes a heating fence, two connecting portions and two conductive pins arranged along a length direction of the resistive heating element, the heating fence is located in a middle of the resistive heating element, a plurality of through holes are provided through the heating fence, the two connecting portions are respectively located on two opposite sides of the heating fence and are interconnected by the heating fence, the two conductive pins are located at two opposite ends of the resistive heating element and are connected with the two connecting portions respectively;
placing the resistive heating element on a first mold, wherein the first mold is provided with a first molding groove and a first supporting platform surrounded by the first molding groove, the resistive heating element is arranged on the first supporting platform and at least partially extends to the first molding groove;
combining a second mold with the first mold, wherein the second mold is provided with a second molding groove and a second supporting platform located in the second molding groove, the heating fence is sandwiched between the first supporting platform and the second supporting platform;
injecting a molten material into the first molding groove and the second molding groove, wherein the molten material at least partially covers the resistive heating element, and the molten material after being solidified forms an atomizing base, the atomizing base and the resistive heating element are combined to form a heating assembly and the resistive heating element is at least partially embedded in the atomizing base, wherein the atomizing base includes a base plate and a side wall extending from a periphery of the base plate, a receiving cavity is formed in the atomizing base and enclosed by the base plate and the side wall, an atomizing opening penetrates through the base plate, and the atomizing opening is aligned with the heating fence, wherein the first molding groove is configured for injection molding to form the side wall of the atomizing base, the second molding groove is configured for injection molding to form the base plate of the atomizing base, the first supporting platform is configured to form the receiving cavity in the atomizing base, and the second supporting platform is configured to form the atomizing opening in the base plate; and
separating the second mold from the first mold and taking out the heating assembly.

An embodiment of the present disclosure further provides an assembly method of an atomizer. The assembly method includes:
providing the heating assembly as described above; and
providing an oil guiding member and installing the oil guiding member in the receiving cavity, wherein the oil guiding member is in contact with the heating fence and the base plate.

In the heating assembly and atomizer provided by the embodiment of the present disclosure, the resistive heating element is combined with the atomizing base to form a heating assembly. Such a heating assembly can be assembled simply and can realize automatic assembly and production, to effectively improve the production efficiency and product stability, and ensure the quality consistency of the atomizing structure. At the same time, the oil guiding member is in full and close contact with the resistive heating element of the heating assembly, thereby effectively improving the atomization effect and avoiding the generation of burning smell to affect the taste of smoking during atomization.

The manufacturing method of the heating assembly can form the atomizing base on the resistive heating element by injection molding, and the manufacturing process is simple and fast, and the heating assembly can be produced in batches and quickly, with high production efficiency and low manufacturing cost. Further, the heating assembly made by the manufacturing method is an integrated structure, which is convenient for assembly with other structures of the atomizer and meets the requirements of automatic production. In addition, the heating assembly formed by the injection molding does not require complicated post-processing like ceramics, to effectively improve the production efficiency and product stability, and ensure the quality consistency of the atomizer.

The assembly method of the atomizer can assemble the heating assembly and the oil guiding member together. The assembly method is simple and can realize automatic assembly and production. The heating assembly and the oil guiding member can be assembled into an atomizer as a whole, which can improve the assembly efficiency of the atomizer.

### BRIEF DESCRIPTION OF THE DRAWINGS

FIG. 1 is a partially exploded view of an atomizer according to a first embodiment of the present disclosure.

FIG. 2 is a fully exploded view of the atomizer in FIG. 1.

FIG. 3 is a fully exploded view of the atomizer in FIG. 1 from a different viewing angle.

FIG. 4 is a top view of the atomizer in FIG. 1.

FIG. 5 is a cross-sectional view of the atomizer along line A-A in FIG. 4.

FIG. 6 is a cross-sectional view of the atomizer along line B-B in FIG. 4.

FIG. 7 is a schematic view of the heating assembly and the oil guiding member in FIG. 2.

FIG. 8 is a schematic view showing the assembly of the heating assembly and the oil guiding member in FIG. 7.

FIG. 9 is another view of the heating assembly in FIG. 7.

FIG. 10 is a schematic view of the resistive heating element before two ends thereof are bent.

FIG. 11 is a schematic view when two ends of the resistive heating element have not been bent after the resistive heating element is embedded in the atomizing base.

FIG. 12 is a cross-sectional view along line C-C in FIG. 8.

FIG. 13 is a schematic view of a heating assembly according to another example of the present disclosure.

FIG. 14 is a schematic view of the heating assembly in FIG. 13 from a different viewing angle.

FIG. 15 is a partially enlarged view of the heating assembly in FIG. 14.

FIG. 16 is a cross-sectional view of the heating assembly in FIG. 14 along the width direction.

FIG. 17 is a cross-sectional view of the heating assembly in FIG. 14 along the length direction.

FIG. 18 is a cross-sectional view of the heating assembly in FIG. 13 along the length direction.

FIG. 19 is similar to FIG. 18, but viewed from a different viewing angle.

FIG. 20 is a cross-sectional view of the heating assembly in FIG. 13 along the width direction.

FIG. 21 is similar to FIG. 20, but viewed from a different viewing angle.

FIG. 22 is a schematic view of the resistive heating element and the connecting frame.

FIG. 23 is an exploded view of a mold assembly for manufacturing the heating assembly.

FIG. 24 is a schematic view of the second mold in FIG. 23 from a different viewing angle.

FIG. 25 is a cross-sectional view of the first mold in FIG. 23 along a first direction.

FIG. 26 is a cross-sectional view of the first mold in FIG. 23 along a second direction.

FIG. 27 is an enlarged view of the portion A of the first mold in FIG. 25.

FIG. 28 is a schematic view of the first mold shown in FIG. 27 with the connecting frame and the resistive heating element being placed thereon.

FIG. 29 is an enlarged view of the portion B of the first mold in FIG. 25.

FIG. 30 is an enlarged view of the portion C of the first mold in FIG. 26.

FIG. 31 is a cross-sectional view of the second mold in FIG. 24 along one direction.

FIG. 32 is an enlarged view of the portion D of the second mold in FIG. 31.

FIG. 33 is a partially cross-sectional view when the second mold is combined to the first mold.

FIG. 34 and FIG. 35 are partially cross-sectional views after the atomizing base is formed on the first mold.

FIG. 36 and FIG. 37 are partially cross-sectional views after the atomizing base is formed on the second mold.

FIG. 38 is a schematic view of the heating assembly formed by the insert molding process.

FIG. 39 is a schematic view of the heating assembly after being separated from the connecting frame.

FIG. 40 is a schematic view of the heating assembly in FIG. 39 from a different viewing angle.

FIG. 41 is a schematic view of the heating assembly in FIG. 39 when the conductive pins are bent to the vertical direction.

FIG. 42 is a schematic view of the heating assembly in FIG. 39 when the conductive pins are further bent to the horizontal direction.

FIG. 43 to FIG. 45 are schematic diagrams of the bending mechanisms used for bending the conductive pins.

FIG. 46 is an exploded view of the heating assembly and the oil guiding member.

FIG. 47 is a schematic view after the oil guiding member is assembled to the heating assembly.

FIG. 48 to FIG. 51 are schematic diagrams when the heating assembly is assembled to the oil guiding bracket.

FIG. 52 to FIG. 59 are schematic diagrams when the bottom bracket is connected to the oil guiding bracket.

FIG. 60 and FIG. 61 are schematic diagrams when the sealing cover is connected to the oil guiding bracket.

FIG. 62 and FIG. 63 are schematic diagrams when the atomizing assembly is installed into the oil storage container.

### DETAILED DESCRIPTION OF PREFERRED EMBODIMENTS

The technical solutions in the embodiments of the present disclosure will be clearly and completely described below with reference to the accompanying drawings in the embodiments of the present disclosure. Obviously, the described embodiments are only part of the embodiments of the present disclosure, not all of the embodiments. Based on the embodiments of the present disclosure, all other embodiments obtained by ordinary technicians in the art without creative work belong to the protection scope of the present disclosure.

It should be noted that in this disclosure, relational terms such as “first” and “second” are only used to distinguish one entity or operation from another entity or operation, and do not necessarily require or imply any such actual relationship or order between these entities or operations.

### First Embodiment

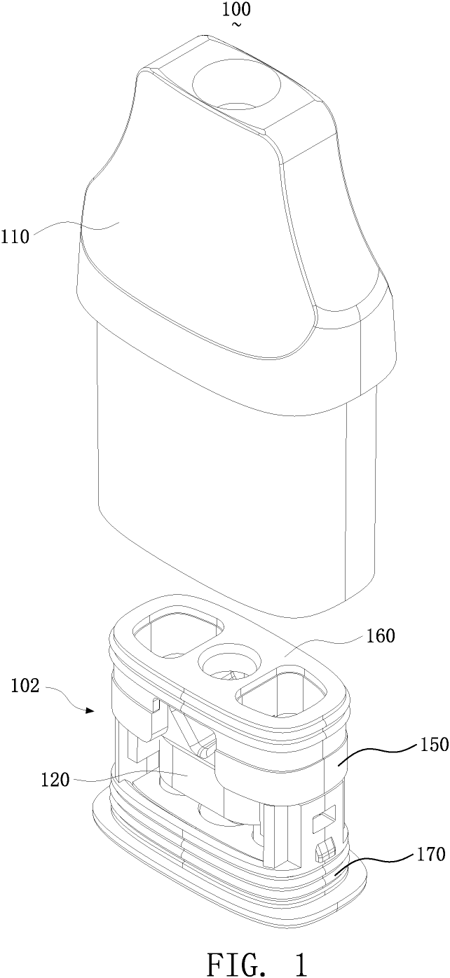

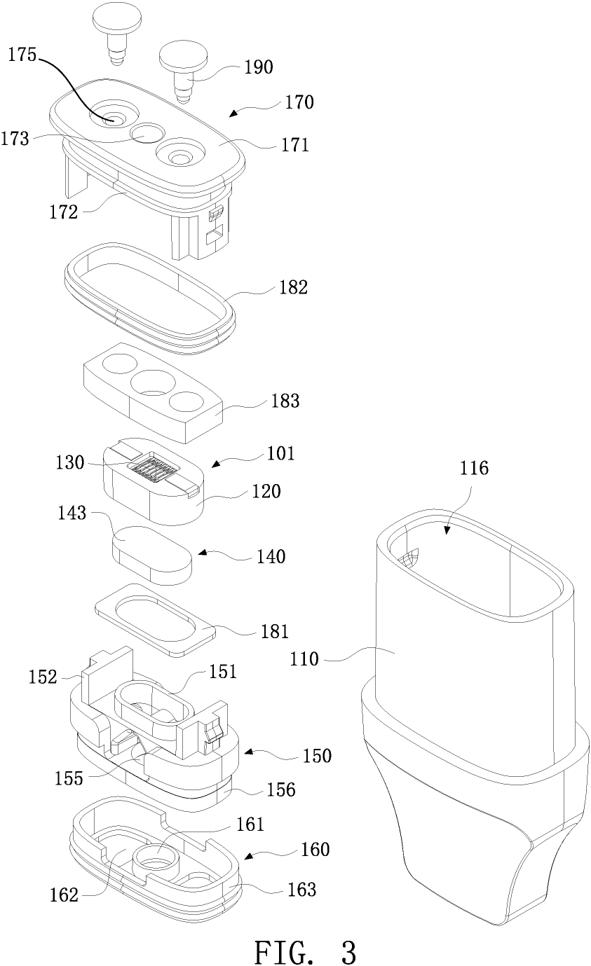

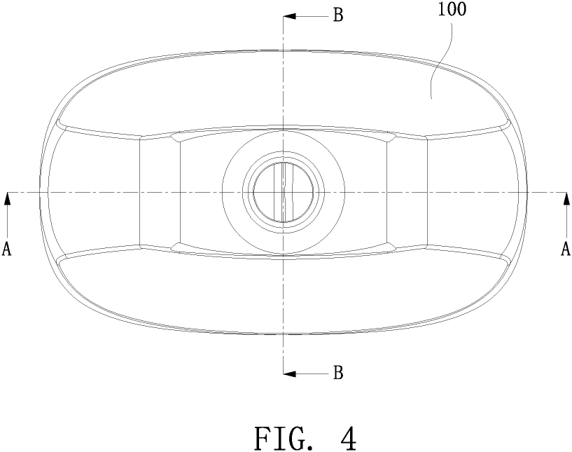

Referring to FIGS. 1-6, a first embodiment of the present disclosure provides an atomizer 100, which includes an oil storage container 110 and an atomizing assembly 102 received in the oil storage container 110. The atomizing assembly 102 includes an atomizing base 120, a resistive heating element 130, an oil guiding member 140, an oil guiding bracket 150, a sealing cover 160 and a bottom bracket 170.

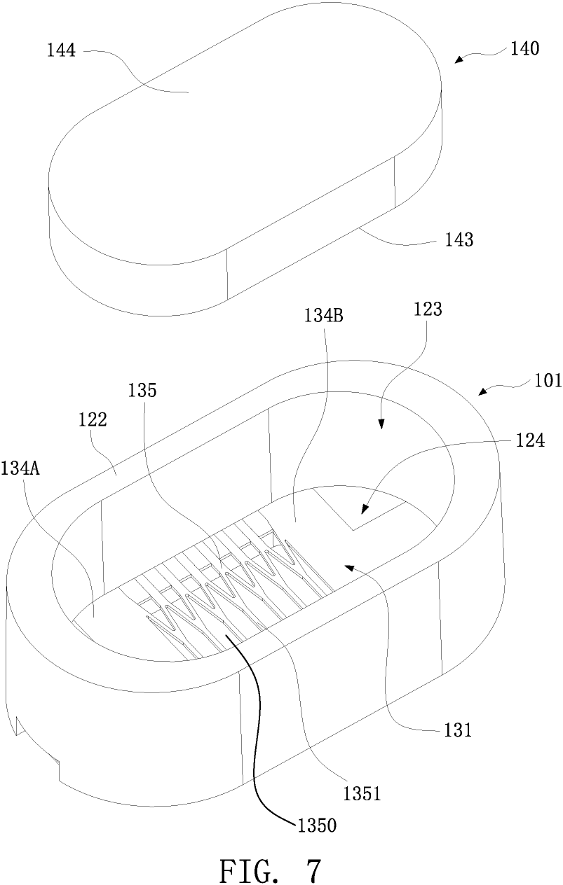

Referring also to FIGS. 7-12, the resistive heating element 130 is combined with the atomizing base 120 to form a heating assembly 101, and specifically, the resistive heating element 130 is at least partially embedded in the atomizing base 120. The atomizing base 120 is provided with a receiving cavity 123 therein. Specifically, the atomizing base 120 includes a base plate 121 and a side wall 122 extending upward from the periphery of the base plate 121. The receiving cavity 123 is formed in the atomizing base 120 and enclosed by the base plate 121 and the side wall 122. The oil guiding member 140 is received in the receiving cavity 123, and the oil guiding member 140 is in direct contact with the resistive heating element 130. Specifically, the resistive heating element 130 has a sheet structure and is made of a metal sheet. The resistive heating element 130 includes an upper surface 131 facing the oil guiding member 140 and an opposite lower surface 132 away from the oil guiding member 140. The oil guiding member 140 includes a lower surface 143 facing the resistive heating element 130 and an opposite upper surface 144 away from the resistive heating element 130. The lower surface 143 of the oil guiding member 140 is in close contact with the upper surface 131 of the resistive heating element 130.

Specifically, the resistive heating element 130 includes two connecting portions 134 (i.e., a first connecting portion 134A and a second connecting portion 134B) and a heating fence 135 along the length direction of the resistive heating element 130. The heating fence 135 is located in the middle of the resistive heating element 130. A plurality of through holes 1350 are provided through the heating fence 135, so that the heating fence 135 is formed by a plurality of resistive heating wires 1351 which are interconnected with each other, and the through holes 1350 are provided between adjacent resistive heating wires 1351. The first connecting portion 134A and the second connecting portion 134B are respectively located on two opposite sides of the heating fence 135, that is, the heating fence 135 is located between the first connecting portion 134A and the second connecting portion 134B, and the first connecting portion 134A and the second connecting portion 134B are interconnected by the heating fence 135. Specifically, the first connecting portion 134A and the second connecting portion 134B are flat plates. The first connecting portion 134A, the second connecting portion 134B and the heating fence 135 are located in the same plane. The lower surface 143 of the oil guiding member 140 is in close contact with the first connecting portion 134A, the second connecting portion 134B and the heating fence 135.

The base plate 121 of the atomizing base 120 includes an upper surface 124 and an opposite lower surface 125. Specifically, the lower surface 132 of the resistive heating element 130 is at least partially embedded in the base plate 121, and the upper surface 131 of the resistive heating element 130 is located in the same plane as the upper surface 124 of the base plate 121, that is, the upper surface of the heating fence 135 and the upper surface of each connecting portion 134A/134B are located in the same plane as the upper surface 124 of the base plate 121. When the oil guiding member 140 is placed in the receiving cavity 123, the lower surface 143 of the oil guiding member 140 is in contact with the upper surface 131 of the resistive heating element 130 and the upper surface 124 of the base plate 121. Specifically, the lower surface 143 of the oil guiding member 140 is in contact with the upper surface of the heating fence 135, the upper surface of each connecting portion 134A/134B and the upper surface 124 of the base plate 121.

The atomizing base 120 includes an atomizing opening 126. The atomizing opening 126 is provided in the middle of the base plate 121 and penetrates through the base plate 121. The heating fence 135 is disposed at the position corresponding to the atomizing opening 126, that is, the heating fence 135 is aligned with the atomizing opening 126. The atomizing opening 126 is in communication with the heating fence 135. Specifically, the heating fence 135 is located above the atomizing opening 126, so that the heating fence 135 spans the atomizing opening 126. The heating fence 135 is exposed to the receiving cavity 123. The atomizing opening 126 is in communication with the receiving cavity 123 via the through holes 1350 of the heating fence 135. Thus, the smoke generated by atomization can enter the airflow channel inside the atomizer 100 through the through holes 1350 and the atomizing opening 126, and be taken away by the external air entering the atomizer 100 for the user to inhale.

In this embodiment, the resistive heating element 130 is combined with the atomizing base 120, and then the oil guiding member 140 is received in the atomizing base 120 and is directly in close contact with the resistive heating element 130. In this way, the assembly is simple, and the automatic assembly and production can be realized, which can effectively improve the production efficiency and product stability, and ensure the quality consistency of the atomizing structure. Further, the resistive heating element 130 is in full and close contact with the oil guiding member 140, which can effectively improve the atomization effect and avoid the influence of burning smell to affect the taste of smoking during atomization.

Specifically, the resistive heating element 130 is in the form of a metal sheet, the upper surface 131 and the lower surface 132 of the resistive heating element 130 are flat surfaces and are parallel to each other. The oil guiding member 140 has a block structure, the lower surface 143 and the upper surface 144 of the oil guiding member 140 are flat surfaces and are parallel to each other. The oil guiding member 140 can cause the smoke oil to be evenly absorbed and transmitted to the resistive heating element 130, so as to improve the atomization effect. The oil guiding member 140 may be an oil guide cotton or be made of other material having the oil absorbing capability.

The resistive heating element 130 further includes two conductive pins 136 (i.e., a first conductive pin 136A and a second conductive pin 136B). The first conductive pin 136A and the second conductive pin 136B are respectively located at two opposite ends of the resistive heating element 130 along the length direction of the resistive heating element 130. The first conductive pin 136A and the second conductive pin 136B are connected with the first connecting portion 134A and the second connecting portion 134B respectively, wherein the first connecting portion 134A is connected between the heating fence 135 and the first conductive pin 136A, and the second connecting portion 134B is connected between the heating fence 135 and the second conductive pin 136B. In this embodiment, the two connecting portions 134, the heating fence 135 and the two conductive pins 136 are formed in an integral structure from a single metal sheet. When the resistive heating element 130 is energized, the heating fence 135, the two connecting portions 134 and the two conductive pins 136 generate heat, or only the heating fence 135 and the two connecting portions 134 generate heat, or only the heating fence 135 generates heat.

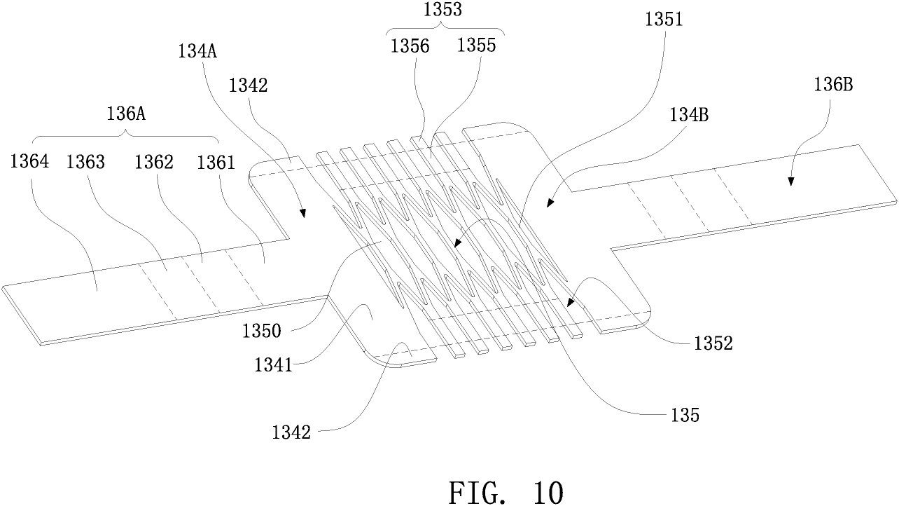

Referring to FIG. 10, each of the first and second connecting portions 134A, 134B includes an intermediate segment 1341 and two first embedding segments 1342. The intermediate segment 1341 and two first embedding segments 1342 are arranged along the width direction of the resistive heating element 130, and the intermediate segment 1341 is connected between the two first embedding segments 1342. The lower surface of the intermediate segment 1341 is embedded in the base plate 121, the upper surface of the intermediate segment 1341 is coplanar with the upper surface 124 of the base plate 121 and exposed to the receiving cavity 123. The two first embedding segments 1342 are embedded in the connection position between the base plate 121 and the side wall 122.

Specifically, each of the first and second conductive pins 136A, 136B is in the shape of an elongated structure and includes a second embedding segment 1361, a third embedding segment 1362, a bending segment 1363 and an electrode segment 1364. The second embedding segment 1361, the third embedding segment 1362, the bending segment 1363 and the electrode segment 1364 are arranged along the length direction of the resistive heating element 130 in sequence. The second embedding segment 1361 is perpendicularly connected to the intermediate segment 1341 of the first connecting portion 134A or the second connecting portion 134B. The third embedding segment 1362 is connected between the second embedding segment 1361 and the bending segment 1363. The bending segment 1363 is connected between the third embedding segment 1362 and the electrode segment 1364. The lower surface of the second embedding segment 1361 is embedded in the base plate 121, and the upper surface of the second embedding segment 1361 is coplanar with the upper surface 124 of the base plate 121 and exposed to the receiving cavity 123. The third embedding segment 1362 is embedded in the connection position between the base plate 121 and the side wall 122. The bending segment 1363 and the electrode segment 1364 extend to the outside of the atomizing base 120.

Specifically, two embedding parts 1352 are provided at two opposite ends of the heating fence 135 along the width direction of the resistive heating element 130. The heating fence 135 is connected between the two embedding parts 1352. Each embedding part 1352 includes a plurality of embedding legs 1353 which are spaced apart from each other along the length direction of the resistive heating element 130. Each of the embedding legs 1353 includes a fourth embedding segment 1355 and a fifth embedding segment 1356 along the width direction of the resistive heating element 130, and the fourth embedding segment 1355 is connected between the fifth embedding segment 1356 and the heating fence 135. The lower surface of the fourth embedding segment 1355 is embedded in the base plate 121, and the upper surface of the fourth embedding segment 1355 is coplanar with the upper surface 124 of the base plate 121 and exposed to the receiving cavity 123. The fifth embedding segment 1356 is embedded in the connection position between the base plate 121 and the side wall 122.

Specifically, when the oil guiding member 140 is placed in the receiving cavity 123, the lower surface 143 of the oil guiding member 140 is in contact with the upper surface of the heating fence 135, the upper surface of each intermediate segment 1341, the upper surface of each second embedding segment 1361 and the upper surface 124 of the base plate 121.

The resistive heating element 130 is made of metal, for example, the resistive heating element 130 is a metal sheet made of nickel chromium alloy, iron chromium aluminum, S316L stainless steel, or other alloy materials. The atomizing base 120 is made of a thermoplastic material or a thermosetting material with a high thermal decomposition temperature and that is able to tolerate rapid temperature change. For example, the atomizing base 120 may be made of plastic, rubber or silicone. The resistive heating element 130 is combined with the atomizing base 120 through an insert molding process, with the resistive heating element 130 as the insert. Specifically, when forming the atomizing base 120, the resistive heating element 130 is placed in a molding cavity of a mold assembly (as will be described below), and then molten material is injected into the molding cavity of the mold assembly, so that the molten material at least partially covers the resistive heating element 130, and after cooling, the atomizing base 120 is formed, and the resistive heating element 130 is at least partially embedded in the atomizing base 120.

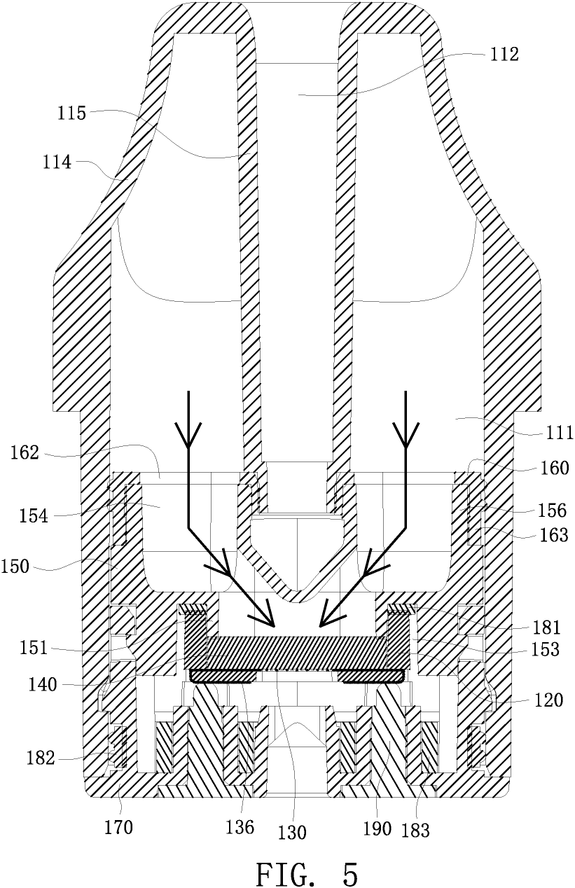

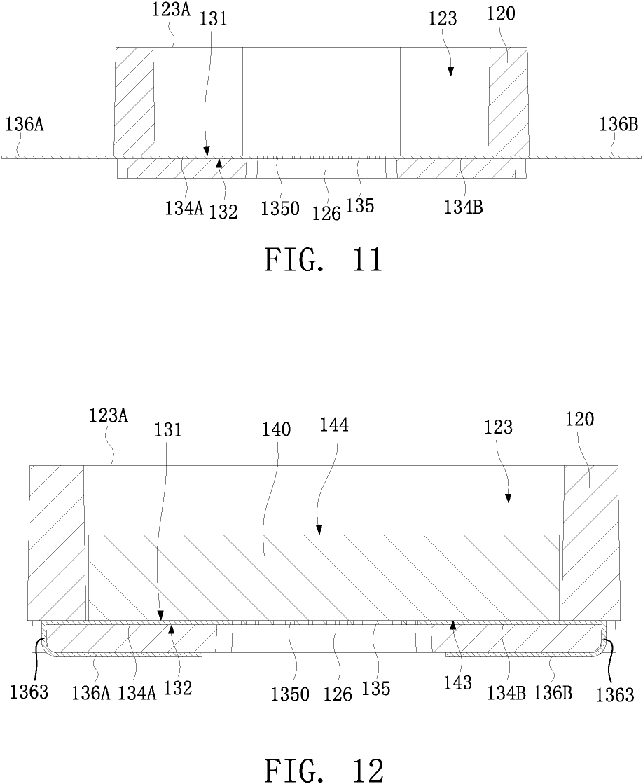

Referring to FIG. 11 and FIG. 12, after the resistive heating element 130 is embedded in the atomizing base 120 by the insert molding process, two ends of the resistive heating element 130 extend horizontally out of the atomizing base 120 (FIG. 11). Then, a being mechanism (as will be described below) is used to bend two ends of the resistive heating element 130 downward and inward (FIG. 12), such that the bending segment 1363 is arranged at the outer peripheral surface of the base plate 121, and the electrode segment 1364 is arranged at the lower surface 125 of the base plate 121 and is in contact with the lower surface 125 of the base plate 121. Since the electrode segment 1364 is exposed on the lower surface 125 of the base plate 121, each of the conductive pins 136A, 136B is convenient to electrically connect with the conductive electrode 190 (FIG. 5).

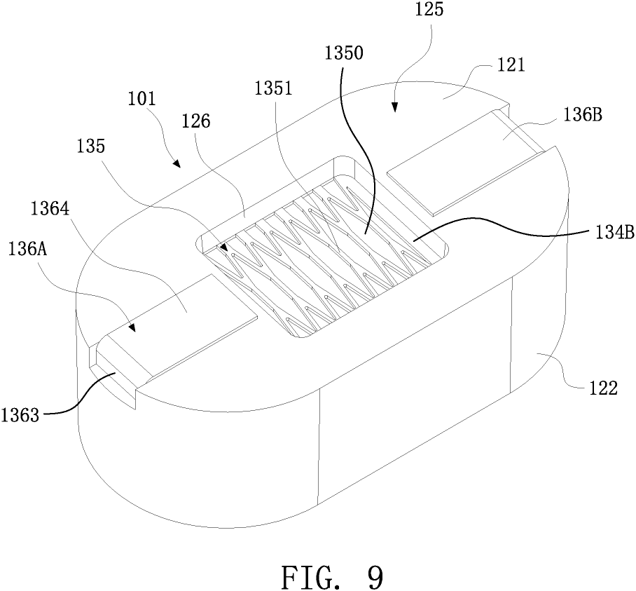

Referring to FIG. 9 and FIG. 12, the lower surface 132 of the resistive heating element 130 is higher than the lower surface 125 of the base plate 121 of the atomizing base 120, and a specific distance is formed between them, preferably 0.5 mm to 2.0 mm.

The outline of the oil guiding member 140 matches the shape of the receiving cavity 123, and the oil guiding member 140 is snugly received in the receiving cavity 123. Specifically, the upper end of the receiving cavity 123 is formed with an opening 123A, and the oil guiding member 140 is placed into the receiving cavity 123 via the opening 123A. The oil guiding member 140 is removably received in the receiving cavity 123, that is, the oil guiding member 140 can be placed into or removed from the receiving cavity 123. The oil guiding member 140 has the ability to absorb smoke oil, while the atomizing base 120 does not have the ability to absorb smoke oil. The atomizing base 120 is used to combine the resistive heating element 130, and accommodate and support the oil guiding member 140. By limiting the oil guiding member 140 in the receiving cavity 123, the smoke oil absorbed into the receiving cavity 123 through the oil guiding member 140 can be supplied downward to the resistive heating element 130 for atomization, which can effectively prevent the leakage of the smoke oil and the oil splashing during atomization.

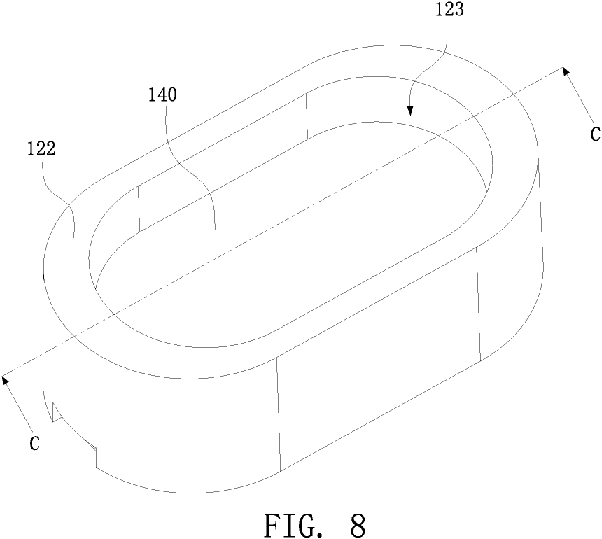

Referring to FIG. 8 and FIG. 12, the oil guiding member 140 is completely accommodated in the receiving cavity 123, and the upper surface 144 of the oil guiding member 140 is lower than the upper surface of the side wall 122 of the atomizing base 120.

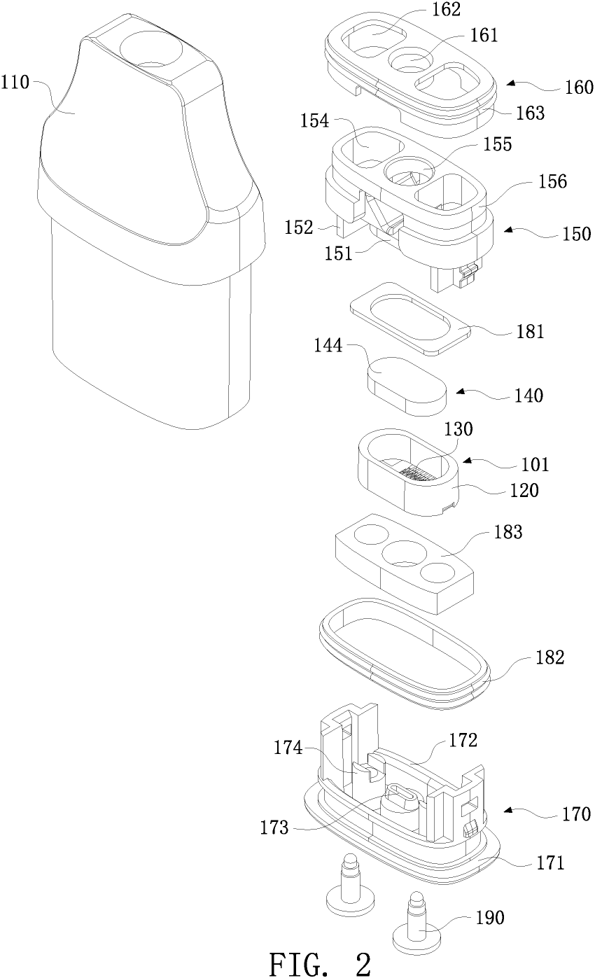

Referring to FIGS. 2 to 6, the oil guiding bracket 150 is arranged above the atomizing base 120. The lower end of the oil guiding bracket 150 is provided with an annular pressing wall 151, which extends into the receiving cavity 123 and abuts against the periphery of the upper surface 144 of the oil guiding member 140. Thus, a downward pressure is applied to the oil guiding member 140 by the pressing wall 151, so that the oil guiding member 140 is sandwiched between the pressing wall 151 and the base plate 121 to prevent the oil guiding member 140 from loosening and displacement, and the oil guiding member 140 can better fit in the receiving cavity 123 and contact with the resistive heating element 130 to improve the atomization effect.

The lower end of the oil guiding bracket 150 is further provided with two baffle plates 152, which are arranged oppositely to each other. The pressing wall 151 is located between the two baffle plates 152 with a gap 153 formed between the pressing wall 151 and the two baffle plates 152, and the side wall 122 of the atomizing base 120 is inserted into the gap 153. By limiting the side wall 122 of the atomizing base 120 in the gap 153, the atomizing base 120 can be stably installed in the atomizer 100.

A sealing pad 181 is further provided in the gap 153, and the sealing pad 181 is sandwiched between the upper surface of the side wall 122 of the atomizing base 120 and the lower surface of the oil guiding bracket 150. The sealing pad 181 has an annular structure, and the middle of the sealing pad 181 is provided with a through hole (not labelled) for the pressing wall 151 to pass through. The sealing pad 181 can prevent the smoke oil absorbed into the receiving cavity 123 from leaking from the upper surface of the side wall 122.

The oil guiding bracket 150 is provided with two first liquid inlet holes 154 on both sides thereof. The oil storage container 110 is provided with an oil storage chamber 111 for storing smoke oil. Each first liquid inlet hole 154 communicates the oil storage chamber 111 with the oil guiding member 140, so that the smoke oil in the oil storage chamber 111 can be transmitted to the oil guiding member 140 through the first liquid inlet holes 154.

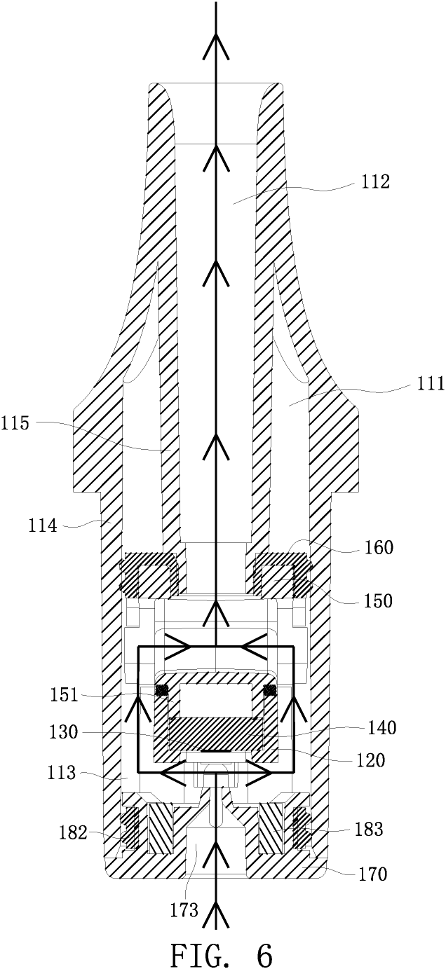

The oil guiding bracket 150 is provided with a first air outlet hole 155 in the middle thereof. The first air outlet hole 155 is located between the two first liquid inlet holes 154. The oil storage container 110 is provided with a smoke outlet channel 112 which is isolated from the oil storage chamber 111. An air outlet channel 113 (FIG. 6) is formed between the outer surface of the atomizing base 120 and the inner surface of the oil storage container 110. The first air outlet hole 155 communicates the air outlet channel 113 with the smoke outlet channel 112, so that the airflow in the atomizer 100 can flow to the smoke outlet channel 112 through the air outlet channel 113 and the first air outlet hole 155.

The sealing cover 160 is arranged above the oil guiding bracket 150. The sealing cover 160 is provided with a second air outlet hole 161 in the middle thereof. The second air outlet hole 161 communicates the first air outlet hole 155 with the smoke outlet channel 112, so that the airflow in the atomizer 100 can flow to the smoke outlet channel 112 through the air outlet channel 113, the first air outlet hole 155 and the second air outlet hole 161 in sequence. The sealing cover 160 is provided with two second liquid inlet holes 162 on both sides thereof corresponding to the two first liquid inlet holes 154. Each second liquid inlet hole 162 communicates the oil storage chamber 111 with a corresponding first liquid inlet hole 154, so that the smoke oil in the oil storage chamber 111 can be transmitted to the oil guiding member 140 through the second liquid inlet holes 162 and the first liquid inlet holes 154 in sequence.

The oil storage container 110 includes an outer casing 114 and an inner casing 115 located in the outer casing 114. The lower end of the outer casing 114 is an open end and is provided with an installation opening 116. The atomizing assembly 102 is installed in the installation opening 116. The inner casing 115 is connected with the upper end of the outer casing 114. The oil storage chamber 111 is formed between the outer casing 114 and the inner casing 115. Specifically, the oil storage chamber 111 is an annular groove provided around the inner casing 115. The smoke outlet channel 112 is formed inside the inner casing 115. The air outlet channel 113 is formed between the outer surface of the side wall 122 of the atomizing base 120 and the inner surface of the outer casing 114.

The sealing cover 160 has a side wall 163, and the upper end of the oil guiding bracket 150 has a side wall 156. The side wall 163 of the sealing cover 160 is sandwiched between the side wall 156 of the oil guiding bracket 150 and the inner surface of the outer casing 114. The lower end of the inner casing 115 is inserted into the second air outlet hole 161, so that the outer surface at the lower end of the inner casing 115 closely abuts against the sealing cover 160 to prevent the smoke oil in the oil storage chamber 111 from leaking.

The bottom bracket 170 is arranged below the oil guiding bracket 150, and the bottom bracket 170 is installed at the installation opening 116 of the outer casing 114. The bottom bracket 170 includes a bottom plate 171 and a side wall 172 extending upward from the periphery of the bottom plate 171. The bottom plate 171 of the bottom bracket 170 is provided with an air inlet hole 173. The external air enters the atomizer 100 from the air inlet hole 173, then carries the smoke generated by atomization to flow through the air outlet channel 113, the first air outlet hole 155, the second air outlet hole 161 and the smoke outlet channel 112 in sequence, and finally is discharged out for the user to inhale.

The atomizer 100 further includes a sealing ring 182. The sealing ring 182 has an annular structure and is sleeved on or integrally formed with the side wall 172 of the bottom bracket 170. The sealing ring 182 is sandwiched between the outer surface of the side wall 172 of the bottom bracket 170 and the inner surface of the outer casing 114 to prevent the smoke oil from leaking out from the installation opening 116 at the lower end of the outer casing 114.

Specifically, the inner surface of the bottom plate 171 of the bottom bracket 170 extends upward to provide with two mounting posts 174 which are hollow. The bottom plate 171 is provided with a mounting hole 175 corresponding to each of the mounting posts 174. The mounting hole 175 is in communication with the inner space of the mounting post 174. The atomizer 100 further includes two conductive electrodes 190. The two conductive electrodes 190 are respectively inserted into the two mounting posts 174 from the mounting holes 175, the upper ends of the two conductive electrodes 190 are in electrical contact with the electrode segments 1364 of the two conductive pins 136A, 136B of the resistive heating element 130 respectively, and the lower ends of the two conductive electrodes 190 are exposed outside the oil storage container 110 to facilitate the two conductive electrodes 190 to electrically connect with a power supply device (not shown).

The atomizer 100 further includes an oil absorbing member 183. The oil absorbing member 183 has a block structure. The oil absorbing member 183 is arranged on the inner surface of the bottom plate 171 of the bottom bracket 170 and is sleeved on the two mounting posts 174. The oil absorbing member 183 can absorb condensate or smoke oil during atomization to prevent the leakage of the condensate or smoke oil. The oil absorbing member 183 may be an oil absorbing cotton.

In this embodiment, the middle of the base plate 121 of the atomizing base 120 is penetrated with the atomizing opening 126, the middle of the resistive heating element 130 is formed with the heating fence 135, and the heating fence 135 is in communication with the atomizing opening 126, the smoke generated by atomization can enter the airflow channel in the atomizer 100 through the heating fence 135 and the atomizing opening 126, and be taken away by the external air entering the atomizer 100 for the user to inhale.

When the atomizer 100 works, the smoke oil stored in the oil storage chamber 111 of the oil storage container 110 is guided to the upper surface 144 of the oil guiding member 140 through the second liquid inlet holes 162 of the sealing cover 160 and the first liquid inlet holes 154 of the oil guiding bracket 150, and then is absorbed by the oil guiding member 140 and transmitted to the lower surface 143 of the oil guiding member 140 which is in close contact with the resistive heating element 130, as shown by the liquid direction arrows in FIG. 5. The resistive heating element 130 generates heat when energized to atomize the smoke oil in contact with the upper surface 131 of the resistive heating element 130 to form smoke, and the smoke enters the inner cavity of the bottom bracket 170 through the heating fence 135 and the atomizing opening 126. The external air enters the inner cavity of the bottom bracket 170 from the air inlet hole 173 of the bottom bracket 170, then carries the smoke to flow through the air outlet channel 113, the first air outlet hole 155, the second air outlet hole 161 and the smoke outlet channel 112 in sequence, and finally flows out of the oil storage container 110 for the user to inhale, as shown by the airflow direction arrows in FIG. 6.

In this embodiment, the resistive heating element 130 is combined with the atomizing base 120 which may be made by plastic, rubber or silicone to form a heating assembly 101. Such a heating assembly can realize automatic forming and production through the mold assembly, and after forming, there is no need to go through cumbersome post-processing treatment as required by ceramics, to effectively improve the production efficiency and product stability, and ensure the quality consistency of the atomizing structure.

In this embodiment, the inner cavity of the heating assembly 101 is installed with the oil guiding member 140, and the oil guiding bracket 150 is then installed. Under the downward pressure of the oil guiding bracket 150, the oil guiding member 140 is in close contact with the resistive heating element 130 of the heating assembly 101 to form an atomizing structure with heating capacity and oil guiding channel, thereby effectively improving the atomization effect and avoiding the generation of burning smell to affect the taste of smoking during atomization.

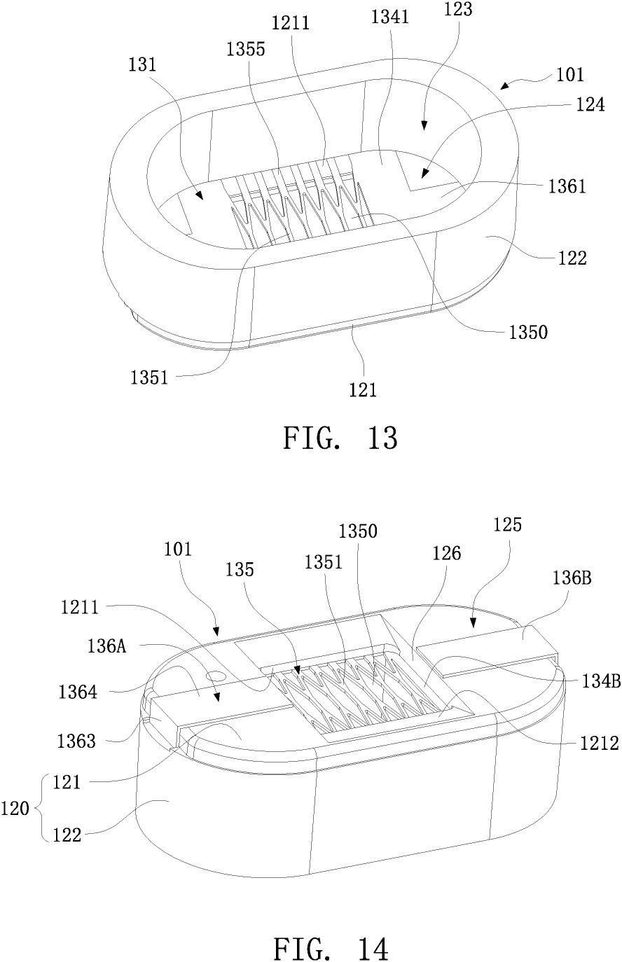

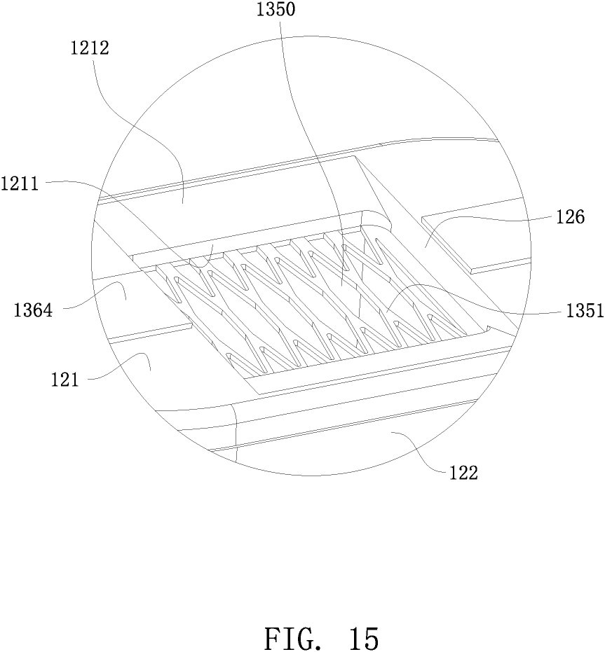

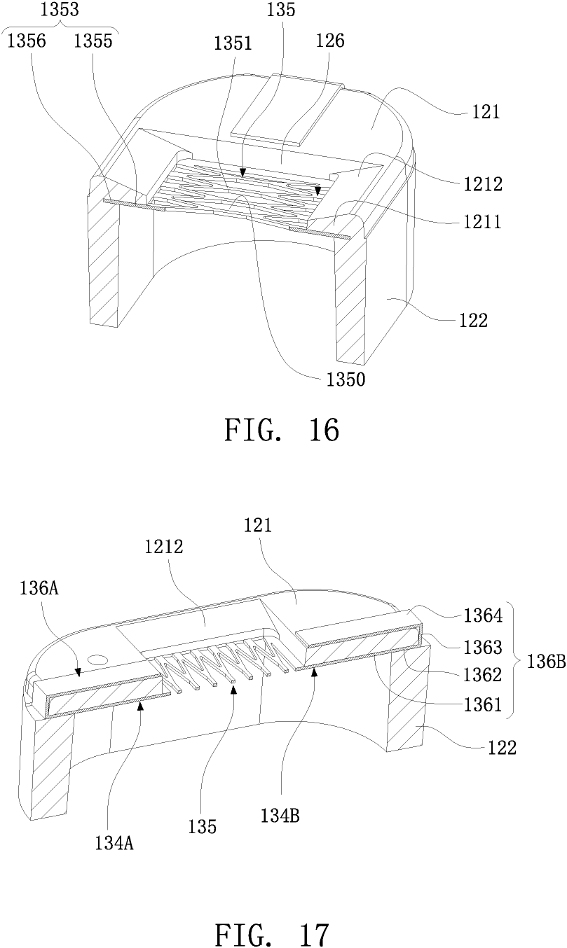

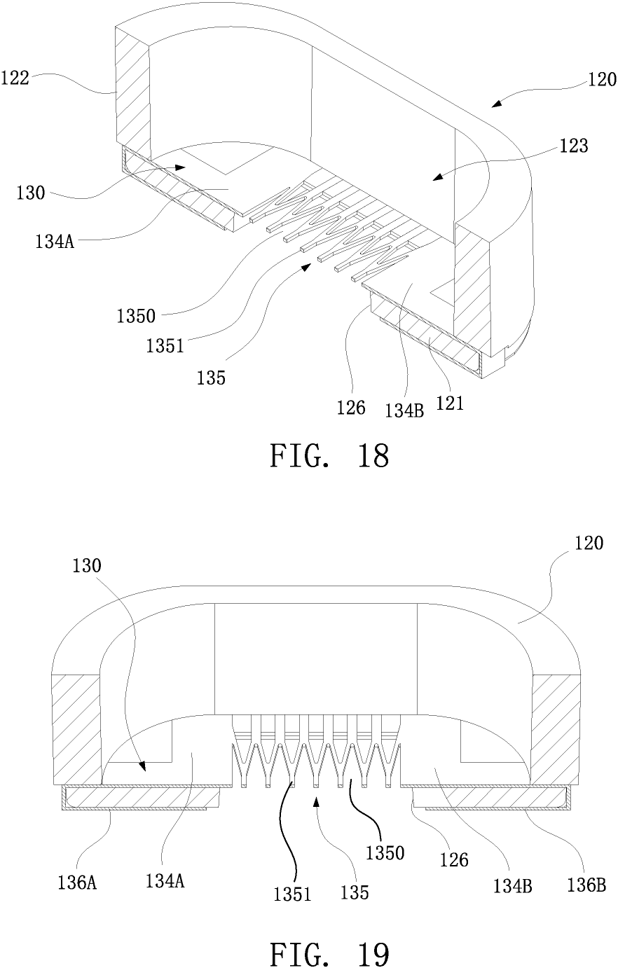

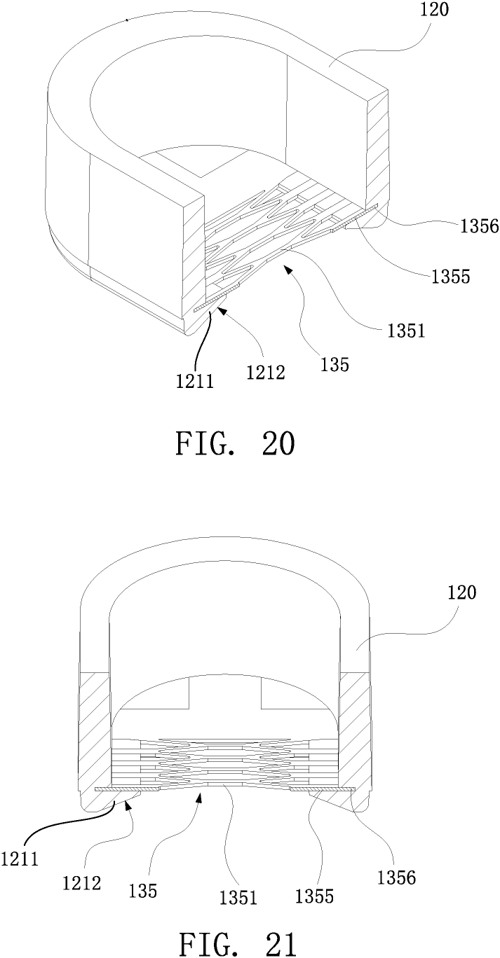

Referring to FIGS. 13-21, another example of the heating assembly 101 is shown. The heating assembly 101 includes an atomizing base 120 and a resistive heating element 130 at least partially embedded in the atomizing base 120. The resistive heating element 130 includes a heating fence 135, two connecting portions 134A, 134B and two conductive pins 136A, 136B arranged along the length direction of the resistive heating element 130. The atomizing base 120 includes a base plate 121 and a side wall 122 extending upward from the periphery of the base plate 121. A receiving cavity 123 is formed in the atomizing base 120 and enclosed by the base plate 121 and the side wall 122. An atomizing opening 126 is provided through the middle of the base plate 121. The heating fence 135 of the resistive heating element 130 is located above the atomizing opening 126 and spans the atomizing opening 126. The heating fence 135 is aligned with the atomizing opening 126. The upper surface 131 of the resistive heating element 130 and the upper surface 124 of the base plate 121 are located in the same plane. When the oil guiding member 140 is installed in the receiving cavity 123, the oil guiding member 140 is in close contact with the resistive heating element 130, thereby effectively improving the atomization effect and avoiding the influence of burning smell to affect the taste of smoking during atomization. The heating assembly shown in FIGS. 13-21 differs from the heating assembly shown in FIGS. 7-12 in that the base plate 121 includes two inclined portions 1211, and the two inclined portions 1211 are located at two opposite sides of the base plate 121 along the width direction of the atomizing base 120. The atomizing opening 126 is located between the two inclined portions 1211. The thickness of each inclined portion 1211 gradually decreases from the side wall 122 to the atomizing opening 126. Specifically, the resistive heating element 130 is in the form of a metal sheet made of, for example, nickel chromium alloy, iron chromium aluminum, S316L stainless steel, or other metals or metal alloy materials. The atomizing base 120 is made of a thermoplastic material or a thermosetting material with high thermal decomposition temperature and being able to withstand rapid temperature change. For example, the atomizing base 120 is made of plastic, rubber, or silicone. The resistive heating element 130 is combined with the atomizing base 120 through an insert molding process, such that the resistive heating element 130 is at least partially embedded in the atomizing base 120.

In the heating assembly 101 shown in this example, the thickness of the inclined portion 1211 gradually decreases from the side wall 122 to the atomizing opening 126. During injection molding to form the atomizing base 120, because the thickness of the inclined portion 1211 at the side close to the atomizing opening 126 is relatively small, the molding material will not flow to the heating fence 135 and thus will not pollute the heating fence 135. That is, the side edge of the inclined portion 1211 located at the atomizing opening 126 will not form a rough edge of the molding material, which can effectively avoid secondary processing (for removing the rough edge) and is conducive to improving the production efficiency, thereby reducing the production cost and ensuring the quality and stability of the products.

In this example, the inclined portion 1211 forms an inclined surface 1212 at the bottom of the base plate 121. Specifically, the inclined surface 1212 is recessed from the lower surface 125 of the base plate 121 and tilts upward from the side wall 122 to the atomizing opening 126.

Specifically, the minimum thickness of the inclined portion 1211 is 0.1 mm to 2 mm.

Further, each of the connecting portions 134A, 134B includes an intermediate segment 1341 and two first embedding segments 1342. The intermediate segment 1341 and two first embedding segments 1342 are arranged along the width direction of the resistive heating element 130, and the intermediate segment 1341 is connected between the two first embedding segments 1342. The lower surface of the intermediate segment 1341 is embedded in the base plate 121, the upper surface of the intermediate segment 1341 is coplanar with the upper surface 124 of the base plate 121 and exposed to the receiving cavity 123. The two first embedding segments 1342 are embedded in the connection position between the base plate 121 and the side wall 122.

Further, each of the conductive pins 136A, 136B is in the shape of an elongated structure and includes a second embedding segment 1361, a third embedding segment 1362, a bending segment 1363 and an electrode segment 1364. The second embedding segment 1361, the third embedding segment 1362, the bending segment 1363 and the electrode segment 1364 are arranged along the length direction of the resistive heating element 130 in sequence. The second embedding segment 1361 is perpendicularly connected to the intermediate segment 1341 of the connecting portion 134A/134B. The third embedding segment 1362 is connected between the second embedding segment 1361 and the bending segment 1363. The bending segment 1363 is connected between the third embedding segment 1362 and the electrode segment 1364. The lower surface of the second embedding segment 1361 is embedded in the base plate 121, and the upper surface of the second embedding segment 1361 is coplanar with the upper surface 124 of the base plate 121 and exposed to the receiving cavity 123. The third embedding segment 1362 is embedded in the connection position between the base plate 121 and the side wall 122. The bending segment 1363 and the electrode segment 1364 are extended to the outside of the atomizing base 120. Specifically, the bending segment 1363 is arranged at the outer peripheral surface of the base plate 121, and the electrode segment 1364 is in contact with the lower surface 125 of the base plate 121.

Further, two embedding parts 1352 are provided at two opposite ends of the heating fence 135 along the width direction of the resistive heating element 130. Each embedding part 1352 includes a plurality of embedding legs 1353 which are spaced apart from each other along the length direction of the resistive heating element 130. Each of the embedding legs 1353 includes a fourth embedding segment 1355 and a fifth embedding segment 1356. The fourth embedding segment 1355 and the fifth embedding segment 1356 are arranged along the width direction of the resistive heating element 130, and the fourth embedding segment 1355 is connected between the fifth embedding segment 1356 and the heating fence 135. The lower surface of the fourth embedding segment 1355 is embedded in the inclined portion 1211 of the base plate 121, the upper surface of the fourth embedding segment 1355 is coplanar with the upper surface 124 of the base plate 121 and exposed to the receiving cavity 123. The fifth embedding segment 1356 is embedded in the connection position between the base plate 121 and the side wall 122. The heating fence 135 is connected between the two embedding parts 1352, and the heating fence 135 is aligned with the atomizing opening 126.

In this example, the width direction of the resistive heating element 130 coincides with the width direction of the atomizing base 120, and the length direction of the resistive heating element 130 coincides with the length direction of the atomizing base 120.

### Second Embodiment

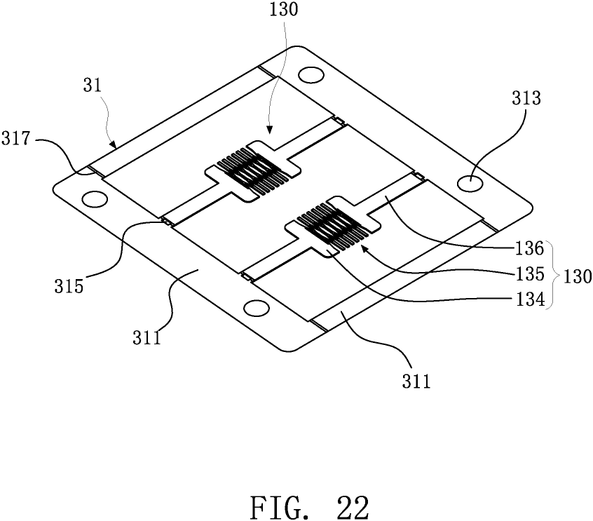

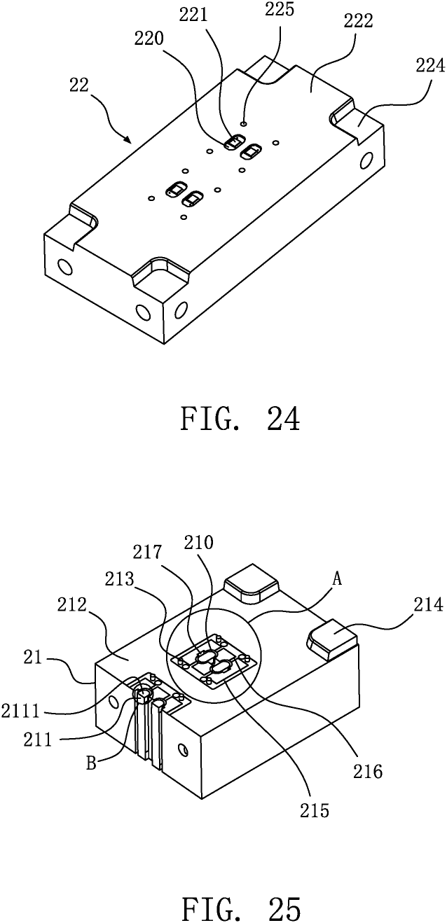

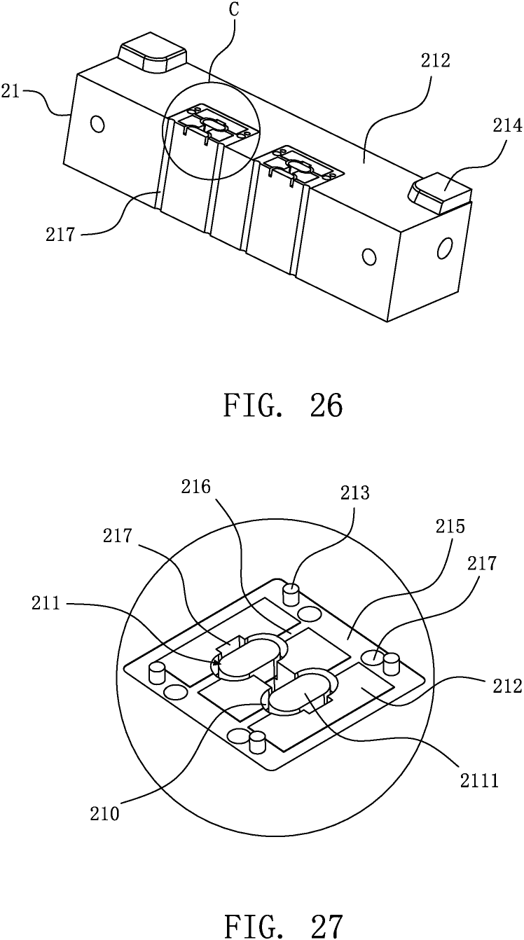

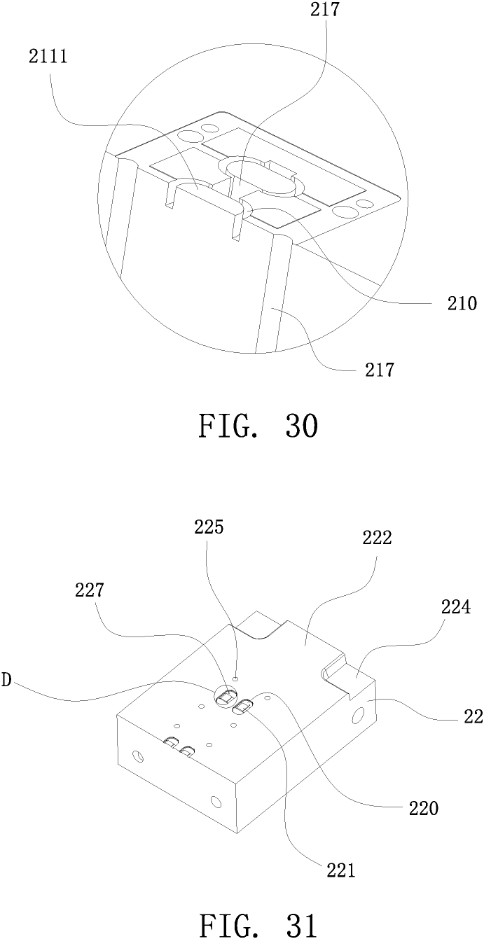

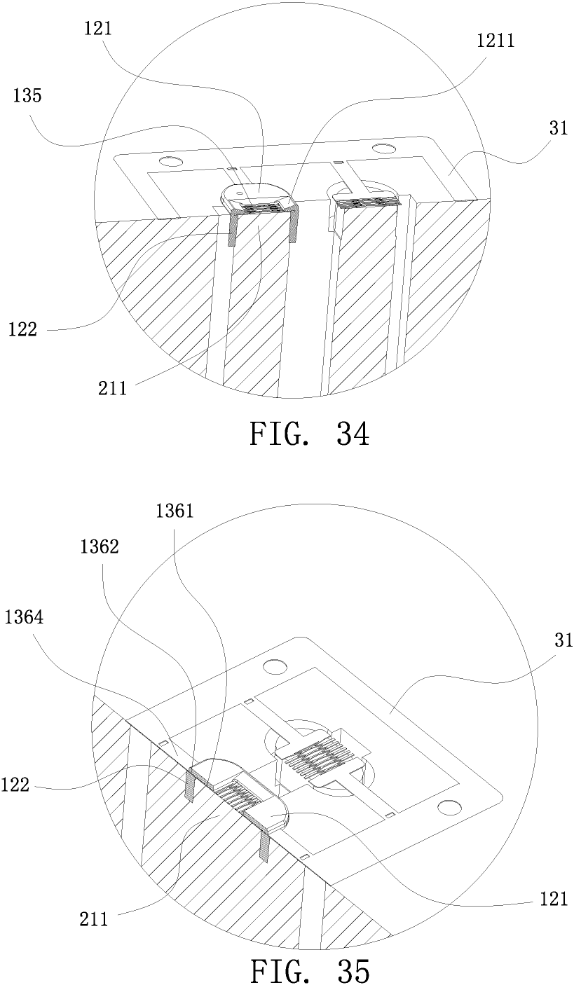

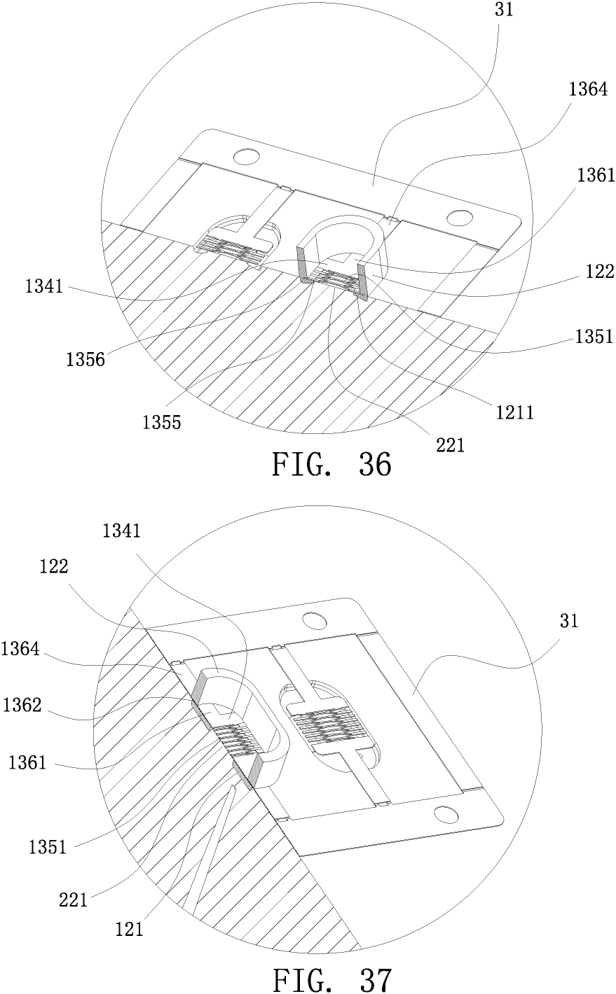

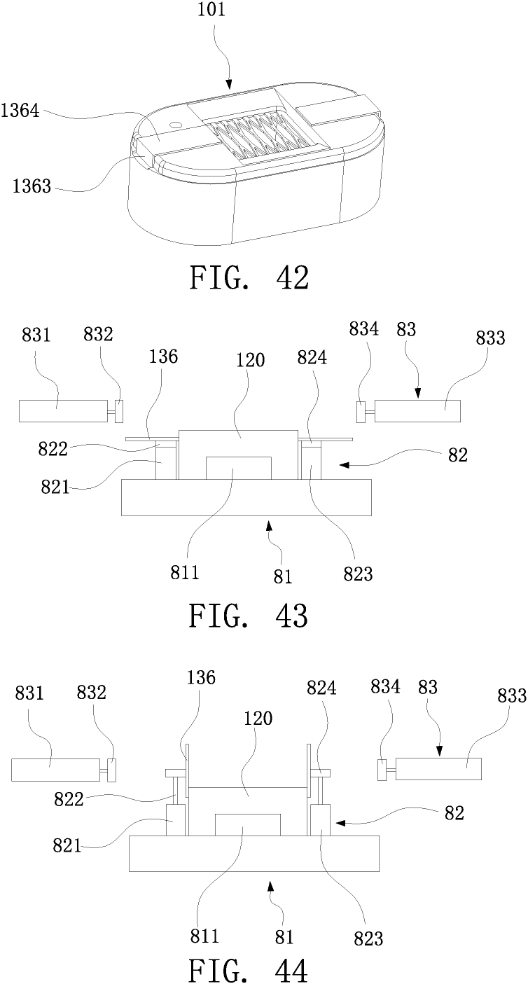

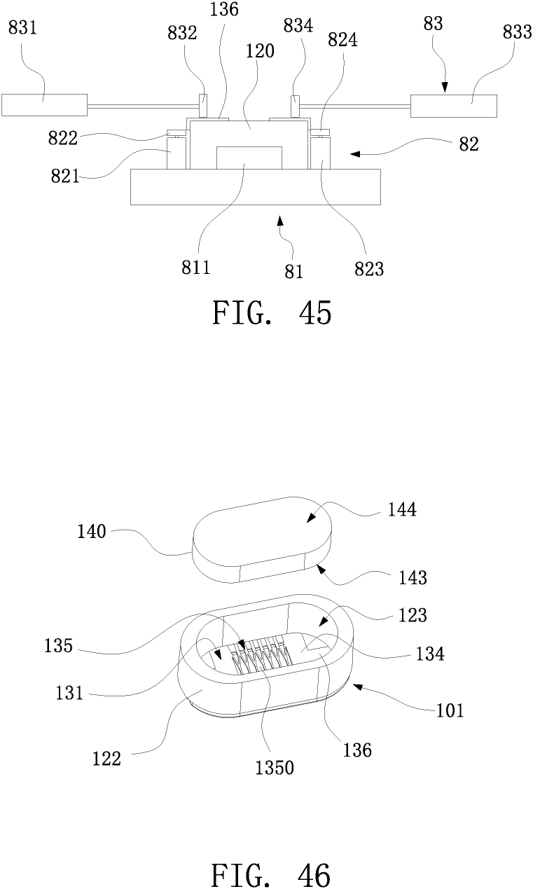

Referring to FIGS. 22-45, a second embodiment of the present disclosure provides a manufacturing method of a heating assembly. The manufacturing method includes the following steps:
providing a resistive heating element 130, wherein the resistive heating element 130 is in the form of a metal sheet, the resistive heating element 130 includes a heating fence 135, two connecting portions 134 and two conductive pins 136 arranged along the length direction of the resistive heating element 130, the heating fence 135 is located in the middle of the resistive heating element 130, a plurality of through holes 1350 are provided through the heating fence 135, the two connecting portions 134 are respectively located on two opposite sides of the heating fence 135 and are interconnected by the heating fence 135, the two conductive pins 136 are located at two opposite ends of the resistive heating element 130 and are connected with the two connecting portions 134 respectively;
placing the resistive heating element 130 on a first mold 21, wherein the first mold 21 is provided with a first molding groove 210 and a first supporting platform 211 surrounded by the first molding groove 210, the resistive heating element 130 is arranged on the first supporting platform 211 and at least partially extends to the first molding groove 210;
combining a second mold 22 with the first mold 21, wherein the second mold 22 is provided with a second molding groove 220 and a second supporting platform 221 located in the second molding groove 220, the heating fence 135 is sandwiched between the first supporting platform 211 and the second supporting platform 221;
injecting a molten material into the first molding groove 210 and the second molding groove 220, wherein the molten material at least partially covers the resistive heating element 130, and the molten material after being solidified forms an atomizing base 120, the atomizing base 120 and the resistive heating element 130 are combined to form a heating assembly 101 and the resistive heating element 130 is at least partially embedded in the atomizing base 120, wherein the atomizing base 120 includes a base plate 121 and a side wall 122 extending from the periphery of the base plate 121, a receiving cavity 123 is formed in the atomizing base 120 and enclosed by the base plate 121 and the side wall 122, an atomizing opening 126 penetrates through the base plate 121, and the atomizing opening 126 is aligned with the heating fence 135, wherein the first molding groove 210 is configured for injection molding to form the side wall 122 of the atomizing base 120, the second molding groove 220 is configured for injection molding to form the base plate 121 of the atomizing base 120, the first supporting platform 211 is configured to form the receiving cavity 123 in the atomizing base 120, and the second supporting platform 221 is configured to form the atomizing opening 126 in the base plate 121; and
separating the second mold 22 from the first mold 21 and taking out the heating assembly 101.

Specifically, the first mold 21 and the second mold 22 together form a mold assembly 20. The atomizing base 120 is made of plastic, rubber or silicone, and the resistive heating element 130 is combined with the atomizing base 120 through an insert molding process. The atomizing base 120 includes a base plate 121 and a side wall 122 extending upward from the periphery of the base plate 121. The side wall 122 is integrally formed with the base plate 121. A receiving cavity 123 is formed in the atomizing base 120 between the base plate 121 and the side wall 122. The middle of the base plate 121 is penetrated with an atomizing opening 126.

During the injection molding process, when the molten material fills the first molding groove 210 and the second molding groove 220 and solidifies, the side wall 122 of the atomizing base 120 is formed in the first molding groove 210, the base plate 121 of the atomizing base 120 is formed in the second molding groove 220, the receiving cavity 123 of the atomizing base 120 is formed due to the first supporting platform 211, the atomizing opening 126 of the atomizing base 120 is formed due to the second supporting platform 221, and the atomizing opening 126 penetrates through the base plate 121. The heating fence 135 of the resistive heating element 130 spans the atomizing opening 126, and the atomizing opening 126 is in communication with the receiving cavity 123 through the through holes 1350 of the heating fence 135. Further, after the injection molding process to form the atomizing base 120, the resistive heating element 130 includes an upper surface 131 and an opposite lower surface 132 both of which are planar surfaces. The base plate 121 includes an upper surface 124 and an opposite lower surface 125 both of which are planar surfaces. The lower surface 132 of the resistive heating element 130 is at least partially embedded in the base plate 121, and the upper surface 131 of the resistive heating element 130 and the upper surface 124 of the base plate 121 are in the same plane. Specifically, the heating fence 135, two connecting portions 134 and two conductive pins 136 are located in the same plane. The heating fence 135 is provided with a plurality of through holes 1350. The heating fence 135 is formed by a plurality of resistive heating wires 1351 which are interconnected with each other, and the through holes 1350 are provided between adjacent resistive heating wires 1351.

The manufacturing method of the heating assembly can form the atomizing base 120 on the resistive heating element 130 by injection molding, and the manufacturing process is simple and fast, and the heating assembly 101 can be produced in batches and quickly, with high production efficiency and low manufacturing cost. Further, the heating assembly 101 made by the manufacturing method is an integrated structure, which is convenient for assembly with other structures of the atomizer and meets the requirements of automatic production. In addition, the heating assembly 101 formed by the injection molding does not require complicated post-processing like ceramics, to effectively improve the production efficiency and product stability, and ensure the quality consistency of the atomizer.

In this embodiment, as shown in FIG. 22, before the injection molding process, at least two resistive heating elements 130 are connected to a connecting frame 31. For example, in this embodiment, two resistive heating elements 130 are connected to the connecting frame 31. Specifically, the connecting frame 31 is a rectangular frame, and the two resistive heating elements 130 are connected to the connecting frame 31 in parallel. In other embodiments, only one or more than two resistive heating elements 130 can be connected to the connecting frame 31. The connecting frame 31 includes four connecting plates 311, the four connecting plates 311 are connected to each other to form a rectangle, both ends of each connecting plate 311 are connected with two adjacent connecting plates 311, and each resistive heating element 130 is connected between two opposite connecting plates 311. Preferably, the connecting frame 31 and the resistive heating elements 130 connected thereto are formed integrally by a metal sheet, that is, the connecting frame 31 and the resistive heating elements 130 connected thereto are integrally formed from a single metal sheet. The through holes 1350 in the heating fence 135 can be formed by machine cutting, laser etching or corrosion.

The heating fence 135, the two connecting portions 134 and the two conductive pins 136 are arranged along the length direction of the resistive heating element 130, wherein the heating fence 135 is located in the middle of the resistive heating element 130, the two connecting portions 134 are respectively located on two opposite sides of the heating fence 135 and are interconnected by the heating fence 135, and the two conductive pins 136 are located at two opposite ends of the resistive heating element 130 and are connected with the two connecting portions 134 respectively. A distal end of each conductive pin 136 far away from the heating fence 135 is connected to the connecting frame 31.

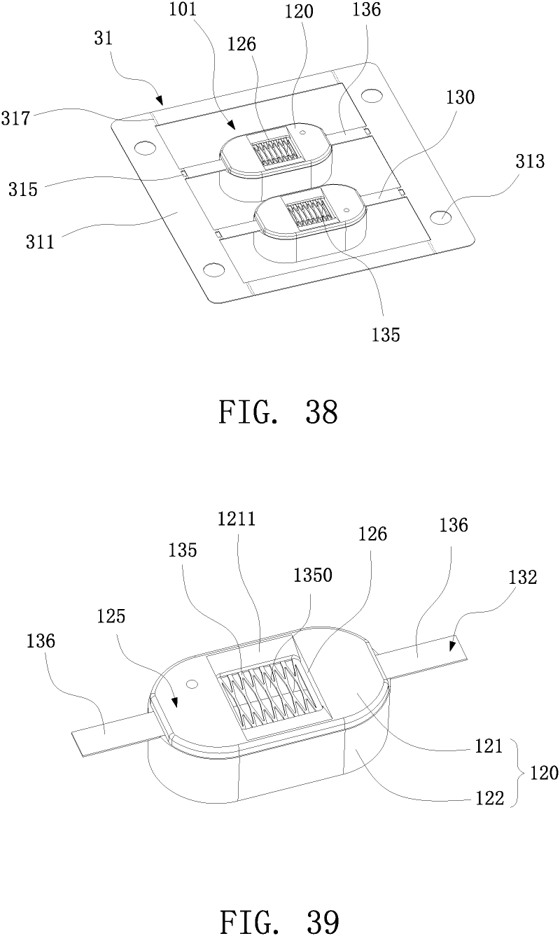

During the injection molding process, the resistive heating elements 130 together with the connecting frame 31 are placed on the first mold 21. After the injection molding process, the atomizing base 120 is formed on each of the resistive heating elements 130, as shown in FIG. 38. Therefore, during each molding process, a plurality of heating assemblies 101 can be produced in batches, thereby improving the production efficiency and reduce the manufacturing cost.

After the injection molding process, the resistive heating element 130 is combined with the atomizing base 120 to form a heating assembly 101, the resistive heating element 130 is at least partially embedded in the atomizing base 120, and the heating assembly 101 is connected to the connecting frame 31. Then, the heating assembly 101 is separated from the connecting frame 31.

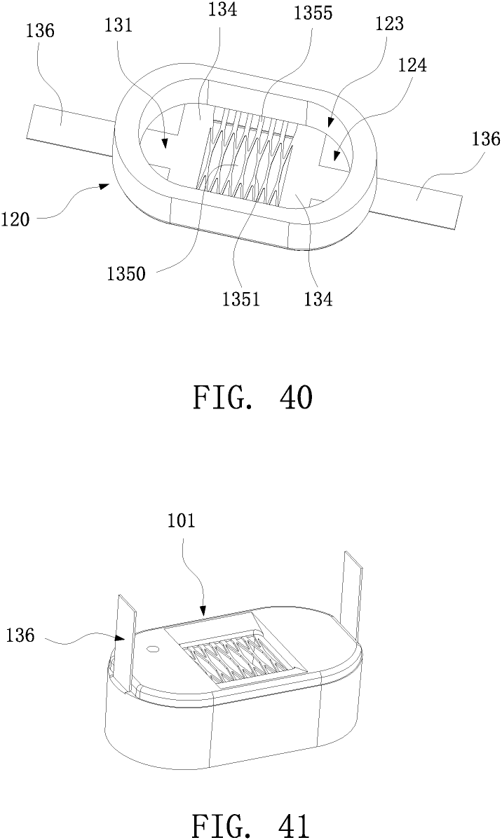

Optionally, in order to facilitate the separation of the heating assembly 101 from the connecting frame 31, a first crease groove 315 is provided at the connection position between each conductive pin 136 and the connecting frame 31, and a second crease groove 317 is provided at the connection position between two adjacent connecting plates 311. The second crease groove 317 is arranged in the same line with the first crease groove 315, so that the heating assembly 101 can be easily separated from the connecting frame 31 by bending along the first crease groove 315 and the second crease groove 317. After the heating assembly 101 is separated from the connecting frame 31, the two conductive pins 136 of the resistive heating element 130 extend horizontally outwardly from both sides of the atomizing base 120, as shown in FIGS. 39 to 40.

Specifically, with reference to FIG. 10, each of the two connecting portions 134 includes an intermediate segment 1341 and two first embedding segments 1342. The intermediate segment 1341 and two first embedding segments 1342 are arranged along the width direction of the resistive heating element 130, and the intermediate segment 1341 is connected between the two first embedding segments 1342. After the injection molding process to form the atomizing base 120, the lower surface of the intermediate segment 1341 is embedded in the base plate 121, the upper surface of the intermediate segment 1341 is coplanar with the upper surface 124 of the base plate 121 and exposed to the receiving cavity 123, and the two first embedding segments 1342 are embedded in the connection position between the base plate 121 and the side wall 122.

Each of the two conductive pins 136 is in the shape of an elongated structure and includes a second embedding segment 1361, a third embedding segment 1362, a bending segment 1363 and an electrode segment 1364. The second embedding segment 1361, the third embedding segment 1362, the bending segment 1363 and the electrode segment 1364 are arranged along the length direction of the resistive heating element 130 in sequence. The second embedding segment 1361 is perpendicularly connected to the intermediate segment 1341 of a corresponding connecting portion 134. The third embedding segment 1362 is connected between the second embedding segment 1361 and the bending segment 1363. The bending segment 1363 is connected between the third embedding segment 1362 and the electrode segment 1364. After the injection molding process to form the atomizing base 120, the lower surface of the second embedding segment 1361 is embedded in the base plate 121, the upper surface of the second embedding segment 1361 is coplanar with the upper surface 124 of the base plate 121 and exposed to the receiving cavity 123, the third embedding segment 1362 is embedded in the connection position between the base plate 121 and the side wall 122, and the bending segment 1363 and the electrode segment 1364 extend horizontally outwardly from both sides of the atomizing base 120.

Specifically, two embedding parts 1352 are provided at two opposite ends of the heating fence 135 along the width direction of the resistive heating element 130. The heating fence 135 are connected between the two embedding parts 1352. Each embedding part 1352 includes a plurality of embedding legs 1353 which are spaced apart from each other along the length direction of the resistive heating element 130. Each of the embedding legs 1353 includes a fourth embedding segment 1355 and a fifth embedding segment 1356. The fourth embedding segment 1355 and the fifth embedding segment 1356 are arranged along the width direction of the resistive heating element 130, and the fourth embedding segment 1355 is connected between the fifth embedding segment 1356 and the heating fence 135. After the injection molding process to form the atomizing base 120, the lower surface of the fourth embedding segment 1355 is embedded in the base plate 121, the upper surface of the fourth embedding segment 1355 is coplanar with the upper surface 124 of the base plate 121 and exposed to the receiving cavity 123, the fifth embedding segment 1356 is embedded in the connection position between the base plate 121 and the side wall 122, and the heating fence 135 is aligned with the atomizing opening 126 of the base plate 121.

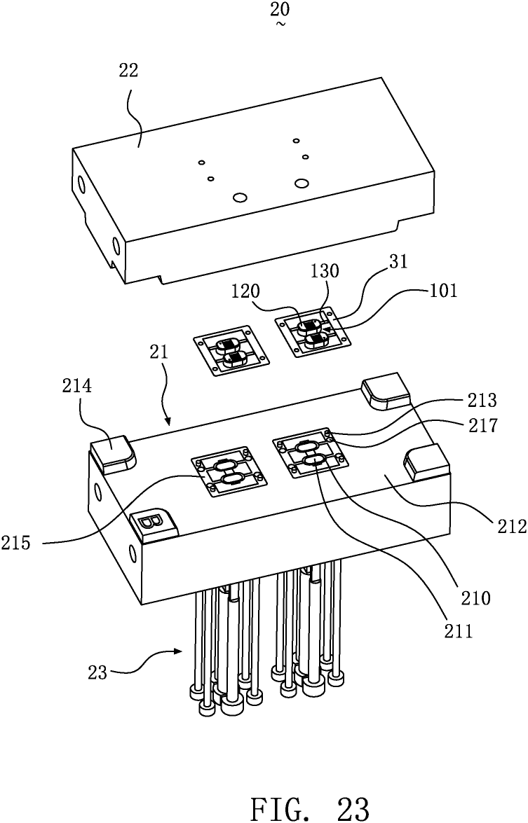

Specifically, as shown in FIGS. 23-26, the first mold 21 includes a first connecting plane 212, the first molding groove 210 is set on the first connecting plane 212, and the first molding groove 210 is formed by locally recessing inwardly from the first connecting plane 212. The second mold 22 includes a second connecting plane 222, the second molding groove 220 is set on the second connecting plane 222, and the second molding groove 220 is formed by locally recessing inwardly from the second connecting plane 222. When the second mold 22 is combined with the first mold 21, the first connecting plane 212 and the second connecting plane 222 are in contact with each other, and the first molding groove 210 and the second molding groove 220 are combined to cooperatively form a molding cavity (not labelled) configured for receiving the molten material and finally forming the atomizing base 120.

In this embodiment, there are four first molding grooves 210 set on the first connecting plane 212, and accordingly, four first supporting platforms 211 are provided on the first mold 21, with each first supporting platform 211 being surrounded by a corresponding first molding groove 210. Every two first molding grooves 210 are formed in a group, that is, during each molding process, two connecting frames 31 can be placed on the first mold 21, each connecting frame 31 is connected with two resistive heating elements 130, and four heating assemblies 101 are formed by the injection molding process each time. It is noted that there are also four second molding grooves 220 set on the second connecting plane 222 and there are four second supporting platforms 221 on the second mold 22, with each second supporting platform 221 being located in a corresponding second molding groove 220. However, the specific number of the first molding groove 210 in the first mold 21 and the second molding groove 220 in the second mold 22 can be adjusted according to actual requirements.

As shown in FIGS. 27-33, the first supporting platform 211 includes a first supporting surface 2111 facing the second mold 22, and the second supporting platform 221 includes a second supporting surface 2211 facing the first mold 21. The first supporting surface 2111 and the second supporting surface 2211 are both planar surfaces. The height of the first supporting surface 2111 is lower than the first connecting plane 212. The second supporting surface 2211 and the second connecting plane 222 are in the same plane.

The first connecting plane 212 is provided with at least a first containing groove 215 and at least a second containing groove 216. The first containing groove 215 is a rectangular groove, the first containing groove 215 is arranged around the first molding groove 210, and the second containing groove 216 is connected between the first containing groove 215 and the first molding groove 210. The first containing groove 215 is configured for receiving the connecting frame 31, and the second containing groove 216 is configured for receiving the part of the conductive pin 136 that extends out of the first molding groove 210 (i.e., the bending segment 1363 and the electrode segment 1364).

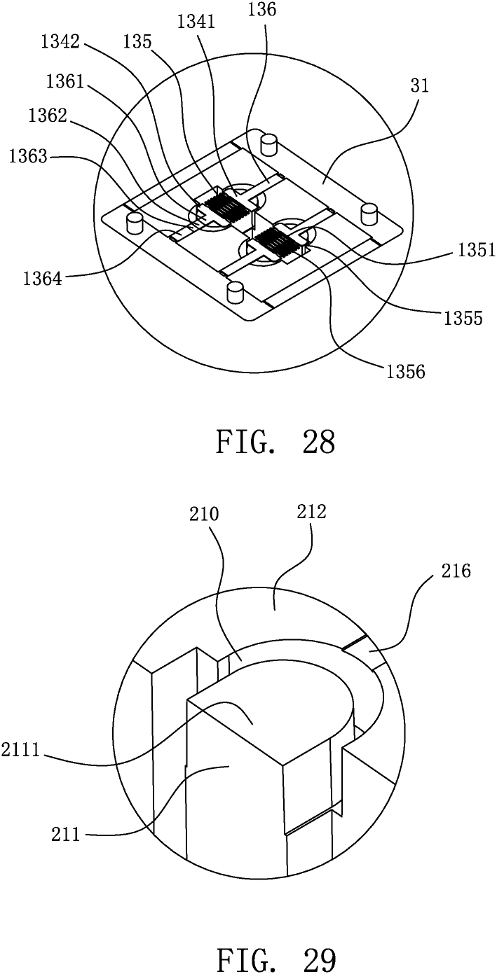

When the connecting frame 31 and the resistive heating element 130 are placed on the first mold 21, the resistive heating wires 1351 of the heating fence 135, the fourth embedding segments 1355 of the two embedding parts 1352, the intermediate segments 1341 of the two connecting portions 134 and the second embedding segments 1361 of the two conductive pins 136 are all supported on the first supporting surface 2111 of the first supporting platform 211, the fifth embedding segments 1356 of the two embedding parts 1352, the first embedding segments 1342 of the two connecting portions 134 and the third embedding segments 1362 of the two conductive pins 136 extend out from the first supporting platform 211 and are located directly above the first molding groove 210, the bending segment 1363 and the electrode segment 1364 of each conductive pin 136 are accommodated in a corresponding second containing groove 216, and the connecting frame 31 is accommodated in the first containing groove 215, as shown in FIG. 28.

As shown in FIG. 33, the area of the first supporting surface 2111 is larger than the area of the second supporting surface 2211. When the second mold 22 is combined with the first mold 21, the second supporting platform 221 is aligned with a middle portion of the first supporting platform 211, a vertical clearance between the first supporting surface 2111 and the second supporting surface 2211 is equal to the thickness of the resistive heating element 130, and the resistive heating wires 1351 of the heating fence 135 are sandwiched between the first supporting surface 2111 and the second supporting surface 2211, wherein the first supporting platform 211 is configured to form the receiving cavity 123 in the atomizing base 120, and the second supporting platform 221 is configured to form the atomizing opening 126 in the base plate 121.

Optionally, the thickness of the connecting frame 31 is equal to the thickness of the resistive heating element 130, the thickness of the connecting frame 31 is equal to the depth of the first containing groove 215, and the thickness of the resistive heating element 130 is equal to the depth of the second containing groove 216, so that when the second mold 22 is combined with the first mold 21, the connecting frame 31 and the resistive heating element 130 can avoid interference with the second mold 22.

Specifically, the first molding groove 210 is an annular groove for injection molding to form the side wall 122 of the atomizing base 120, the first supporting platform 211 is surrounded by the first molding groove 210, and the first supporting platform 211 is configured to form the receiving cavity 123 of the atomizing base 120. The second molding groove 220 includes a groove side wall 2201 and a groove bottom wall 2202, and the second supporting platform 221 is formed at a central position of the groove bottom wall 2202. Thus, an annular groove is formed between the groove side wall 2201 and the peripheral surface of the second supporting platform 221 and configured for injection molding to form the base plate 121 of the atomizing base 120. The second supporting platform 221 is configured to form the atomizing opening 126 of the atomizing base 120.

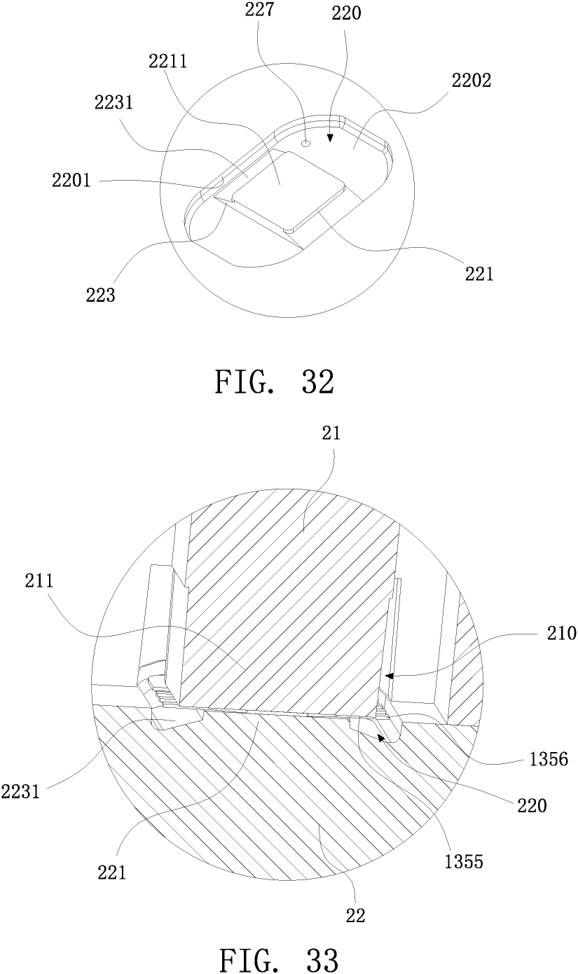

As shown in FIG. 32, in order to form the two inclined portions 1211 located at two opposite sides of the base plate 121 along the width direction of the atomizing base 120, the groove bottom wall 2202 is further provided with two cushion blocks 223. The two cushion blocks 223 are located on two opposite sides of the second supporting platform 221 respectively. One side of the cushion block 223 is connected to the second supporting platform 221, and the other side of the cushion block 223 away from the second supporting platform 221 is located close to the groove side wall 2201. The thickness of the cushion block 223 gradually decreases from the second supporting platform 221 towards the groove side wall 2201. The thickness of the cushion block 223 at the connection between the cushion block 223 and the second supporting platform 221 is the largest, in other words, the spacing between the cushion block 223 and the first supporting surface 2111 at this place is the smallest. Because the molten material injected into the second molding groove 220 has certain viscosity, the molten material will stop flowing when it flows to the narrow spacing, and it will not flow to the heating fence 135 to form the burr of the molding material, thereby avoiding the secondary processing (i.e., for removing the burr), which is conducive to improving production efficiency and reducing production costs.

Specifically, the cushion block 223 includes an inclined surface 2231 extending from the side surface of the second supporting platform 221 to the groove side wall 2201. The inclined surface 2231 is a planar surface or an arced surface. Optionally, the minimum vertical distance between the second supporting surface 2211 and the inclined surface 2231 is 0.1 mm to 2 mm.

As shown in FIGS. 33-37, when the second mold 22 is combined with the first mold 21, the fourth embedding segment 1355 and the fifth embedding segment 1356 of each embedding leg 1353 are located corresponding to the inclined surface 2231 of the cushion block 223. After the injection molding to form the base plate 121 through the second molding groove 220, the inclined portion 1211 of the base plate 121 is formed due to the cushion block 223. The thickness of the inclined portion 1211 gradually decreases from the groove side wall 2201 towards the second supporting platform 221, in other words, the thickness of the inclined portion 1211 gradually decreases from the side wall 122 of the atomizing base 120 to the atomizing opening 126 of the base plate 121.

Optionally, the first mold 21 and/or the second mold 22 are provided with an injection channel 227, and the injection channel 227 is communicated with the first molding groove 210 or the second molding groove 220, so that the molten material can be injected into the first molding groove 210 and the second molding groove 220 through the injection channel 227.

Optionally, as shown in FIGS. 22-27, the first mold 21 is provided with a plurality of fixing columns 213, and one end of each fixing column 213 is fixed in the first containing groove 215. The connecting frame 31 is provided with a plurality of positioning holes 313 corresponding to the fixing columns 213, and the second connecting plane 222 is provided with a plurality of fixing holes 225 corresponding to the fixing columns 213. When the connecting frame 31 and the resistive heating elements 130 are placed on the first mold 21, each fixing column 213 is inserted into a corresponding positioning hole 313. When the second mold 22 is combined with the first mold 21, each fixing column 213 is inserted into a corresponding fixing hole 225. In this embodiment, there are four fixing columns 213 provided in the first containing groove 215 and arranged in a matrix.

Optionally, the first connecting plane 212 is provided with a plurality of positioning blocks 214, and the second connecting plane 222 is provided with a plurality of positioning grooves 224. When the second mold 22 is combined with the first mold 21, each positioning block 214 is engaged into a corresponding positioning groove 224. In this embodiment, the first connecting plane 212 is provided with four positioning blocks 214 which are respectively located at four corners of the first connecting plane 212, and the second connecting plane 222 is provided with four positioning grooves 224 which are respectively located at four corners of the second connecting plane 222.

Optionally, the first mold 21 is provided with a plurality of demolding holes 217. A plurality of demolding pins 23 are provided corresponding to the demolding holes 217, and the demolding pins 23 are inserted into the demolding holes 217 to push the formed heating assembly 101 away from the first mold 21. In this embodiment, the demolding holes 217 run through the bottom surface of the first mold 21 and the first connecting plane 212, wherein four demolding holes 217 are communicated with the first containing groove 215 and another two demolding holes 217 are communicated with the first molding groove 210. When two demolding pins 23 are set in the two demolding holes 217 communicated with the first molding groove 210, the end surfaces of the two demolding pins 23 are in the same plane as the first connecting plane 212, and the side surfaces of the two demolding pins 23 at the first molding groove 210 serve as a portion of the groove wall of the first molding groove 210.

After the injection molding process, the resistive heating element 130 is combined with the atomizing base 120 to form a heating assembly 101, and after the heating assembly 101 is separated from the connecting frame 31, the two conductive pins 136 of the resistive heating element 130 extend horizontally outwardly from both sides of the atomizing base 120, as shown in FIGS. 39-40. Thereafter, each of the conductive pins 136 is bent from the upper surface 124 of the base plate 121 of the atomizing base 120 towards the lower surface 125 of the base plate 121 of the atomizing base 120, as shown in FIGS. 41-45. Specifically, bending the conductive pin 136 includes:
positioning the heating assembly 101;
bending the conductive pin 136 to a vertical direction, so that the bending segment 1363 is arranged at the outer peripheral surface of the base plate 121;
then bending the conductive pin 136 to a horizontal direction, so that the electrode segment 1364 is arranged at the lower surface 125 of the base plate 121 and is in contact with the lower surface 125 of the base plate 121.

Specifically, the heating assembly 101 is positioned by using a positioning mechanism 81. The positioning mechanism 81 may be provided with a clamping unit 811, which can be used to clamp and position the heating assembly 101. The conductive pin 136 is bent to the vertical direction by using a first bending mechanism 82. The first bending mechanism 82 is set in the vertical direction, and the first bending mechanism 82 is used to bend the conductive pin 136 to the vertical direction. The conductive pin 136 is bent to the horizontal direction by using a second bending mechanism 83. The second bending mechanism 83 is set in the horizontal direction, and the second bending mechanism 83 is used to bend the conductive pin 136 to the horizontal direction.

When it is necessary to bend the conductive pin 136, the heating assembly 101 is placed on a bending station. At this time, the positioning mechanism 81 clamps and fixes the atomizing base 120, then the first bending mechanism 82 pushes the two conductive pins 136 to bend toward the vertical direction, and finally the second bending mechanism 83 pushes the two conductive pins 136 to bend toward the horizontal direction. The whole process is performed in one station, thereby reducing the assembly steps and improving the production efficiency.

As shown in FIGS. 43-45, the first bending mechanism 82 includes a first drive 821 and a second drive 823. The first drive 821 and the second drive 823 are respectively set corresponding to the two conductive pins 136. The first drive 821 can push one conductive pin 136 to bend through a first drive shaft 822 extending out along the vertical direction, and the second drive 823 can push another conductive pin 136 to bend through a second drive shaft 824 extending out along the vertical direction. The second bending mechanism 83 includes a third drive 831 and a fourth drive 833. The third drive 831 and the fourth drive 833 are respectively set corresponding to the two conductive pins 136. The third drive 831 can push one conductive pin 136 to bend through a third drive shaft 832 extending out along the horizontal direction, and the fourth drive 833 can push another conductive pin 136 to bend through a fourth drive shaft 834 extending out along the horizontal direction.

### Third Embodiment

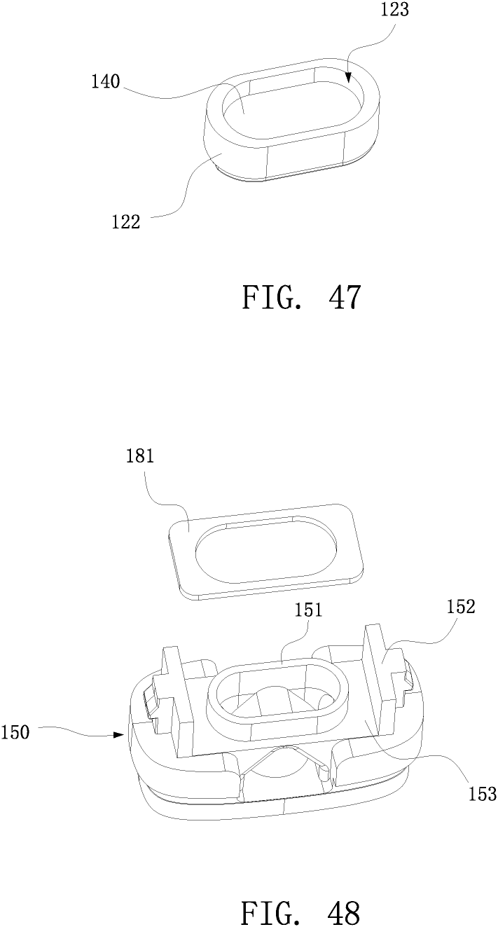

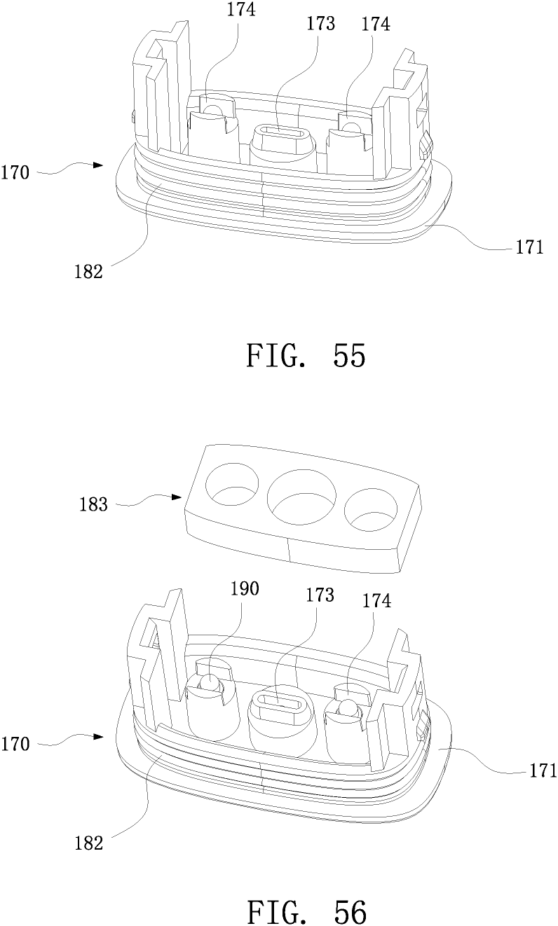

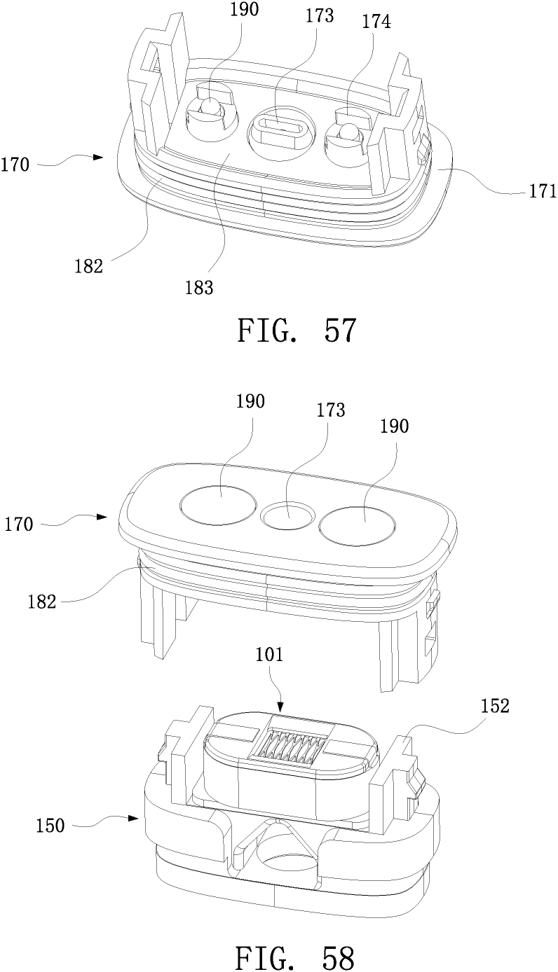

Referring to FIGS. 46-63, a third embodiment of the present disclosure provides an assembly method of an atomizer. The assembly method includes the following steps:
providing a heating assembly 101 as described above; and
providing an oil guiding member 140 and installing the oil guiding member 140 in the receiving cavity 123, wherein the oil guiding member 140 is in contact with the heating fence 135 and the base plate 121.

The assembly method of the atomizer can assemble the heating assembly 101 and the oil guiding member 140 together. The assembly method is simple and can realize automatic assembly and production. The heating assembly 101 and the oil guiding member 140 can be assembled into an atomizer as a whole, which can improve the assembly efficiency of the atomizer.

Optionally, the resistive heating element 130 has a sheet structure, and the resistive heating element 130 is in the form of a metal sheet made of nickel chromium alloy, iron chromium aluminum, S316L stainless steel and other alloy materials. The atomizing base 120 is made of plastic, rubber or silicone. The resistive heating element 130 is combined with the atomizing base 120 through an insert molding process.

Specifically, the resistive heating element 130 includes an upper surface 131 and an opposite lower surface 132. The base plate 121 of the atomizing base 120 includes an upper surface 124 and an opposite lower surface 125. The oil guiding member 140 includes a lower surface 143 and an opposite upper surface 144. The upper surface 131 and the lower surface 132 of the resistive heating element 130, the upper surface 124 and the lower surface 125 of the base plate 121, and the lower surface 143 and the upper surface 144 of the oil guiding member 140 are flat surfaces. The upper surface 131 of the resistive heating element 130 is located in the same plane as the upper surface 124 of the base plate 121. When the oil guiding member 140 is installed in the receiving cavity 123, the lower surface 143 of the oil guiding member 140 is directly in contact with the upper surface 131 of the resistive heating element 130 and the upper surface 124 of the base plate 121 closely, thereby effectively improving the atomization effect and avoiding the generation of burning smell to affect the taste of smoking during atomization.

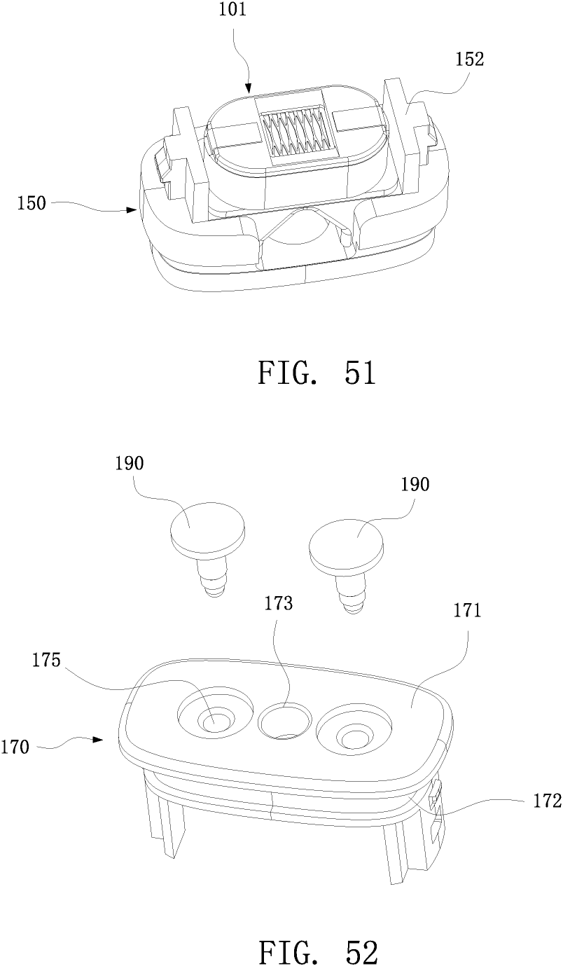

Optionally, as shown in FIGS. 50-51, the assembly method of the atomizer further includes:
providing an oil guiding bracket 150, wherein the oil guiding bracket 150 is provided with at least a first liquid inlet hole 154 and a first air outlet hole 155, the lower end of the oil guiding bracket 150 is provided with an annular pressing wall 151;
attaching the heating assembly 101 to the lower end of the oil guiding bracket 150, such that the pressing wall 151 extends into the receiving cavity 123 and abuts against the oil guiding member 140, the first liquid inlet hole 154 is communicated with the receiving cavity 123, and the smoke oil can be transmitted to the oil guiding member 140 through the first liquid inlet hole 154.

Specifically, the pressing wall 151 extends into the receiving cavity 123 and abuts against the periphery of the upper surface 144 of the oil guiding member 140. A downward pressure is applied to the oil guiding member 140 by the pressing wall 151, so that the oil guiding member 140 is sandwiched between the pressing wall 151 and the base plate 121 to prevent the oil guiding member 140 from loosening and displacement, and the oil guiding member 140 can better fit in the receiving cavity 123 and contact with the resistive heating element 130 to improve the atomization effect.

Optionally, the oil guiding bracket 150 is provided with two first liquid inlet holes 154 and a first air outlet hole 155. The first air outlet hole 155 is located in the middle of the oil guiding bracket 150, and the first air outlet hole 155 is located between the two first liquid inlet holes 154.

Optionally, the lower end of the oil guiding bracket 150 is further provided with two baffle plates 152 which are arranged oppositely to each other. The pressing wall 151 is located between the two baffle plates 152 with a gap 153 being formed between the pressing wall 151 and the two baffle plates 152, and the side wall 122 of the atomizing base 120 is inserted into the gap 153. By limiting the side wall 122 of the atomizing base 120 in the gap 153, the atomizing base 120 can be stably installed in the atomizer 100.

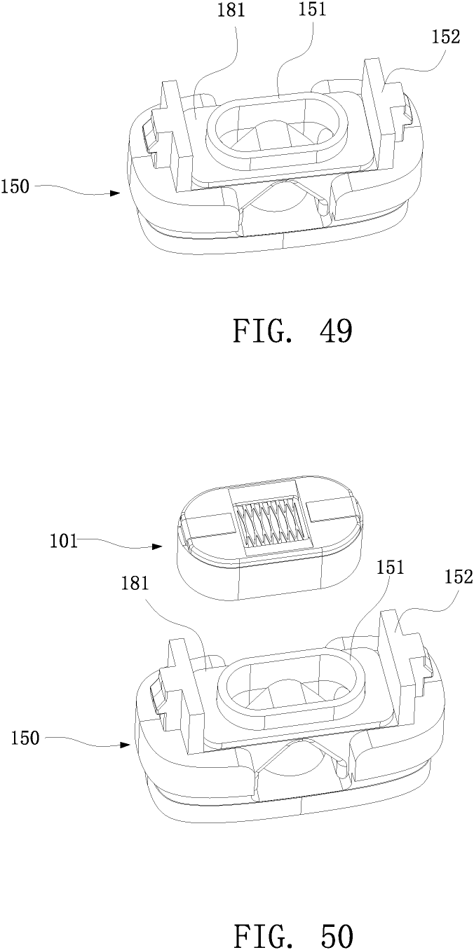

Optionally, as shown in FIGS. 48-49, before attaching the heating assembly 101 to the lower end of the oil guiding bracket 150, the assembly method of the atomizer further includes:

providing a sealing pad 181 and installing the sealing pad 181 to the lower end of the oil guiding bracket 150, such that after attaching the heating assembly 101 to the lower end of the oil guiding bracket 150, the upper surface of the side wall 122 away from the base plate 121 abuts against the sealing pad 181.

Specifically, the sealing pad 181 is installed in the gap 153 and is sandwiched between the upper surface of the side wall 122 of the atomizing base 120 and the lower surface of the oil guiding bracket 150. The sealing pad 181 has an annular structure, and the middle of the sealing pad 181 is provided with a through hole (not labelled) for the pressing wall 151 to pass through. The sealing pad 181 can prevent the smoke oil absorbed into the receiving cavity 123 from leaking from the upper surface of the side wall 122.

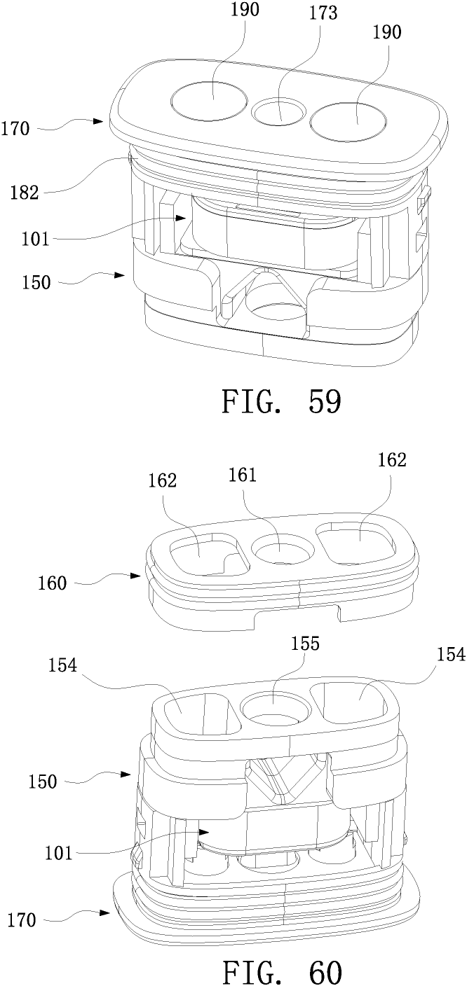

Optionally, as shown in FIGS. 58-59, the assembly method of the atomizer further includes:
providing a bottom bracket 170, wherein the bottom bracket 170 includes a bottom plate 171 and a side wall 172 extending upward from the periphery of the bottom plate 171, and the bottom plate 171 is provided with an air inlet hole 173;
connecting the bottom bracket 170 to the oil guiding bracket 150, such that the heating assembly 10 is located between the oil guiding bracket 150 and the bottom bracket 170, and the atomizing opening 126 is located corresponding to the air inlet hole 173.

Specifically, the bottom bracket 170 is arranged below the oil guiding bracket 150. The bottom bracket 170 can be connected to the oil guiding bracket 150 through clamps and grooves. For example, the outer surfaces of the two baffle plates 152 of the oil guiding bracket 150 are provided with clamps, and the side wall 172 of the bottom bracket 170 is provided with grooves.

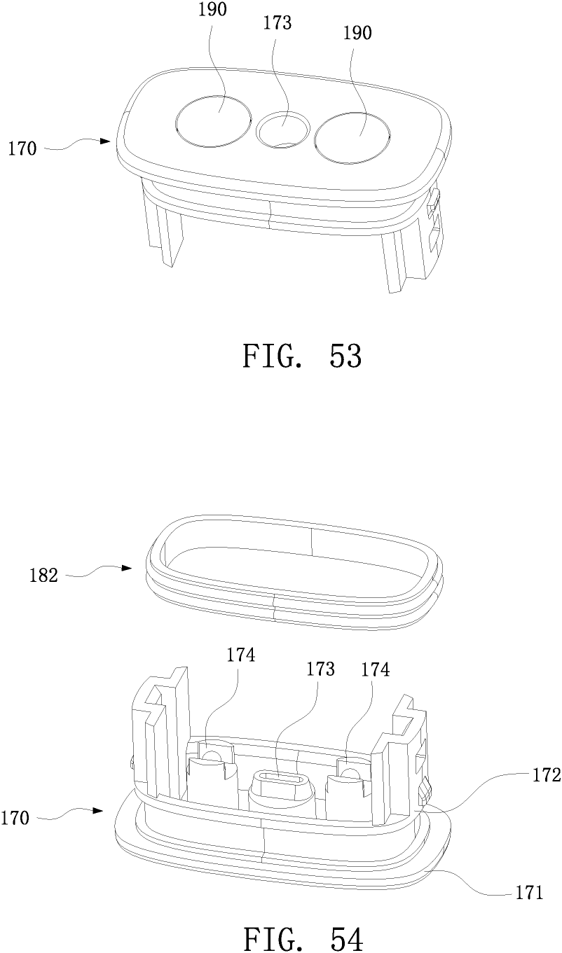

Optionally, as shown in FIGS. 52-53, the assembly method of the atomizer further includes:

providing two conductive electrodes 190 and installing the two conductive electrodes 190 on the bottom bracket 170 before or after connecting the bottom bracket 170 to the oil guiding bracket 150, such that after the bottom bracket 170 is connected to the oil guiding bracket 150, the two conductive electrodes 190 are electrically connected to the two conductive pins 136 of the resistive heating element 130.

Optionally, as shown in FIGS. 54-57, before the bottom bracket 170 is connected to the oil guiding bracket 150, the assembly method of the atomizer further includes:
providing a sealing ring 182 and sleeving the sealing ring 182 on the side wall 172 of the bottom bracket 170, or the sealing ring 182 being integrally formed with the side wall 172 of the bottom bracket 170; and
providing an oil absorbing member 183 and installing the oil absorbing member 183 on the inner surface of the bottom plate 171 of the bottom bracket 170.

Specifically, the inner surface of the bottom plate 171 of the bottom bracket 170 extends upward to provide with two mounting posts 174 which are hollow. The bottom plate 171 of the bottom bracket 170 is provided with a mounting hole 175 corresponding to each mounting post 174. The two conductive electrodes 190 are respectively inserted into the two mounting posts 174 from the mounting holes 175, the upper ends of the two conductive electrodes 190 are in electrical contact with the two conductive pins 136 of the resistive heating element 130 respectively, and the lower ends of the two conductive electrodes 190 are exposed outside the bottom bracket 170 for electrically connecting with a power supply device (not shown).

Specifically, the oil absorbing member 183 has a block structure. The oil absorbing member 183 is arranged on the inner surface of the bottom plate 171 of the bottom bracket 170 and is sleeved on the two mounting posts 174. The oil absorbing member 183 can absorb condensate or smoke oil during atomization to prevent the leakage of the condensate or smoke oil. The oil absorbing member 183 is in the form of an oil absorbing cotton.

Specifically, the sealing ring 182 has an annular structure and is arranged on the side wall 172 of the bottom bracket 170. The sealing ring 182 is sandwiched between the side wall 172 of the bottom bracket 170 and the inner surface of the oil storage container 110 to prevent the smoke oil from leaking out from the oil storage container 110.

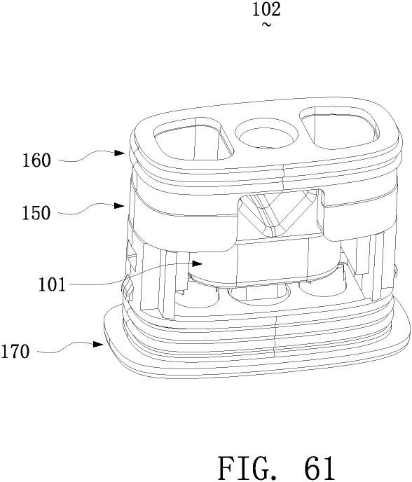

Optionally, as shown in FIGS. 60-61, the assembly method of the atomizer further includes:
providing a sealing cover 160, wherein the sealing cover 160 is provided with at least a second liquid inlet hole 162 and a second air outlet hole 161;
connecting the sealing cover 160 to the oil guiding bracket 150 to form an atomizing assembly 102, such that the second air outlet hole 161 is communicated with the first air outlet hole 155, and the second liquid inlet hole 162 is communicated with the first liquid inlet hole 154.

Specifically, the sealing cover 160 is arranged above the oil guiding bracket 150. The sealing cover 160 is provided with two second liquid inlet holes 162 on both sides thereof and a second air outlet hole 161 in the middle thereof, and each second liquid inlet hole 162 is communicated with a corresponding first liquid inlet hole 154, so that the smoke oil in the oil storage chamber 111 can be transmitted to the oil guiding member 140 through the second liquid inlet holes 162 and the first liquid inlet holes 154 in sequence.

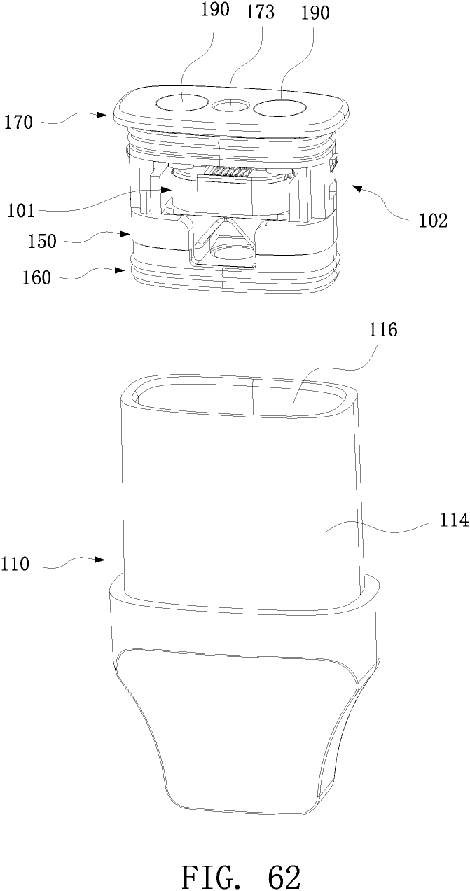

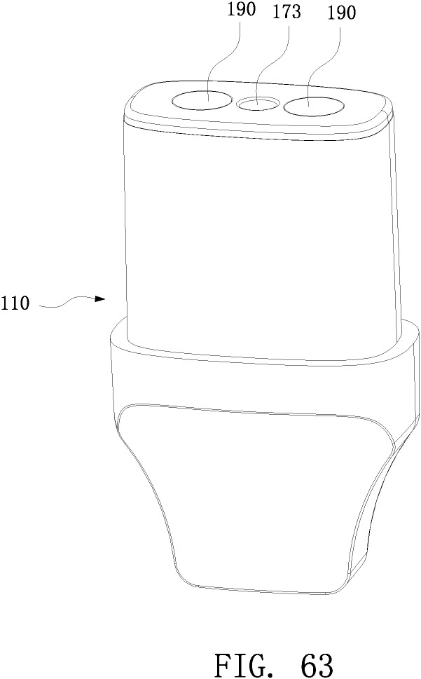

Optionally, as shown in FIGS. 62-63, the assembly method of the atomizer further includes:
providing an oil storage container 110, wherein the oil storage container 110 is provided with an oil storage chamber 111 and a smoke outlet channel 112 therein, and the lower end of the oil storage container 110 is an open end and is provided with an installation opening 116;
installing the atomizing assembly 102 into the oil storage container 110 from the installation opening 116, such that the oil storage chamber 111 is communicated with the second liquid inlet hole 162, and the smoke outlet channel 112 is communicated with the second air outlet hole 161.

Specifically, the atomizing assembly 102 can be connected to the oil storage container 110 through clamps and grooves. For example, the side wall 172 of the bottom bracket 170 is provided with clamps, and the inner surface of the oil storage container 110 is provided with grooves.

Further, an air outlet channel 113 is formed between the outer surface of the atomizing base 120 and the inner surface of the oil storage container 110. The inner cavity of the bottom bracket 170 is communicated with the air inlet hole 173. The air outlet channel 113 communicates the inner cavity of the bottom bracket 170 with the first air outlet hole 155.

When the atomizer 100 works, the smoke oil in the oil storage chamber 111 is guided to the upper surface 144 of the oil guiding member 140 through the second liquid inlet holes 162 of the sealing cover 160 and the first liquid inlet holes 154 of the oil guiding bracket 150, and then is absorbed by the oil guiding member 140 and transmitted to the lower surface 143 of the oil guiding member 140 for atomization by the resistive heating element 130 into smoke. Meanwhile, the external air enters the atomizer 100 from the air inlet hole 173, then carries the smoke generated by atomization to flow through the air outlet channel 113, the first air outlet hole 155, the second air outlet hole 161 and the smoke outlet channel 112 in sequence, and finally flows out of the oil storage container 110 for the user to inhale.

The present disclosure further provides an electronic cigarette, including the above atomizer.

The electronic cigarette further includes a power supply device (not shown), and the power supply device is electrically connected with the atomizer. The power supply device contains a battery, and the power supply device provides the power required for the working of the atomizer.

The above are only the preferred embodiments of the present disclosure and are not intended to limit the present disclosure. Any modifications, equivalent replacements, improvements, etc. made within the spirit and principle of the present disclosure shall be included in the protection scope of the present disclosure.

What is claimed is:

1. A heating assembly, comprising an atomizing base and a resistive heating element at least partially embedded in the atomizing base;
wherein the resistive heating element comprises a heating fence, two connecting portions and two conductive pins arranged along a length direction of the resistive heating element, the heating fence is located in a middle of the resistive heating element, a plurality of through holes are provided through the heating fence, the two connecting portions are respectively located on two opposite sides of the heating fence and are interconnected by the heating fence, the two conductive pins are located at two opposite ends of the resistive heating element and are connected with the two connecting portions respectively;
wherein the atomizing base comprises a base plate and a side wall extending from a periphery of the base plate, a receiving cavity is formed in the atomizing base and enclosed by the base plate and the side wall, an atomizing opening penetrates through the base plate, the atomizing opening is aligned with the heating fence.

2. The heating assembly of claim 1, wherein the heating fence is located above the atomizing opening and spans the atomizing opening, and the atomizing opening is in communication with the receiving cavity through the through holes of the heating fence.

3. The heating assembly of claim 1, wherein the resistive heating element comprises an upper surface and an opposite lower surface, the base plate comprises an upper surface and an opposite lower surface, the lower surface of the resistive heating element is at least partially embedded in the base plate, the upper surface of the resistive heating element and the upper surface of the base plate are in the same plane.

4. The heating assembly of claim 3, wherein the heating fence, the two connecting portions and the two conductive pins are located in the same plane, and the two conductive pins are bent from the upper surface of the base plate towards the lower surface of the base plate to form two electrode segments which are in contact with the lower surface of the base plate.

5. The heating assembly of claim 3, wherein the base plate comprises two inclined portions, the two inclined portions are located at two opposite sides of the base plate along a width direction of the atomizing base, the atomizing opening is located between the two inclined portions, and a thickness of the inclined portion gradually decreases from the side wall to the atomizing opening.

6. The heating assembly of claim 5, wherein the inclined portion has a bottom inclined surface, the bottom inclined surface of the inclined portion is recessed from the lower surface of the base plate and tilts upward from the side wall to the atomizing opening.

7. The heating assembly of claim 5, wherein each of the two connecting portions comprises an intermediate segment and two first embedding segments, the intermediate segment and two first embedding segments are arranged along a width direction of the resistive heating element, and the intermediate segment is connected between the two first embedding segments; a lower surface of the intermediate segment is embedded in the base plate, an upper surface of the intermediate segment is coplanar with the upper surface of the base plate and exposed to the receiving cavity, and the two first embedding segments are embedded in a connection position between the base plate and the side wall.

8. The heating assembly of claim 7, wherein each of the two conductive pins is in the shape of an elongated structure and comprises a second embedding segment, a third embedding segment, a bending segment and an electrode segment, wherein the second embedding segment, the third embedding segment, the bending segment and the electrode segment are arranged along the length direction of the resistive heating element in sequence, the second embedding segment is connected to the intermediate segment of a corresponding connecting portion, the third embedding segment is connected between the second embedding segment and the bending segment, the bending segment is connected between the third embedding segment and the electrode segment; a lower surface of the second embedding segment is embedded in the base plate, an upper surface of the second embedding segment is coplanar with the upper surface of the base plate and exposed to the receiving cavity, the third embedding segment is embedded in a connection position between the base plate and the side wall, the bending segment and the electrode segment extend out from both sides of the atomizing base.

9. The heating assembly of claim 8, wherein two embedding parts are provided at two opposite ends of the heating fence along the width direction of the resistive heating element, the heating fence is connected between the two embedding parts, each embedding part comprises a plurality of embedding legs which are spaced apart from each other along the length direction of the resistive heating element, each of the embedding legs comprises a fourth embedding segment and a fifth embedding segment, the fourth embedding segment is connected between the fifth embedding segment and the heating fence; a lower surface of the fourth embedding segment is embedded in the inclined portion of the base plate, an upper surface of the fourth embedding segment is coplanar with the upper surface of the base plate and exposed to the receiving cavity, the fifth embedding segment is embedded in a connection position between the base plate and the side wall.

10. The heating assembly of claim 1, wherein the resistive heating element is in the form of a metal sheet, and the resistive heating element is combined with the atomizing base through an insert molding process with the resistive heating element as an insert.

11. An atomizer, comprising the heating assembly of claim 1 and an oil guiding member received in the atomizing base and in contact with the resistive heating element and the base plate.

12. The atomizer of claim 11, wherein the resistive heating element comprises an upper surface and an opposite lower surface, the base plate comprises an upper surface and an opposite lower surface, the oil guiding member comprises a lower surface and an opposite upper surface, wherein the upper surface of the resistive heating element and the upper surface of the base plate are located in the same plane, the lower surface of the oil guiding member is in contact with the upper surface of the resistive heating element and the upper surface of the base plate.

13. The atomizer of claim 12, wherein the oil guiding member is completely contained in the receiving cavity, and the upper surface of the oil guiding member is lower than an upper surface of the side wall of the atomizing base; the atomizer further comprises an oil guiding bracket, the oil guiding bracket is arranged above the atomizing base, a lower end of the oil guiding bracket is provided with an annular pressing wall, and the pressing wall extends into the receiving cavity and abuts against a periphery of the upper surface of the oil guiding member.

14. The atomizer of claim 13, wherein the oil guiding bracket is provided with a first air outlet hole in a middle thereof and two first liquid inlet holes on both sides thereof, the atomizer further comprises an oil storage container, the oil storage container is provided with an oil storage chamber for storing smoke oil and a smoke outlet channel isolated from the oil storage chamber, each first liquid inlet hole communicates the oil storage chamber with the oil guiding member, an air outlet channel is formed between the atomizing base and the oil storage container, and the first air outlet hole communicates the air outlet channel with the smoke outlet channel.

15. The atomizer of claim 14, wherein the atomizer further comprises a sealing cover, the sealing cover is arranged above the oil guiding bracket, the sealing cover is provided with a second air outlet hole in a middle thereof and two second liquid inlet holes on both sides thereof corresponding to the two first liquid inlet holes, the second air outlet hole communicates the first air outlet hole with the smoke outlet channel, and each second liquid inlet hole communicates the oil storage chamber with a corresponding first liquid inlet hole, wherein the smoke oil in the oil storage chamber is guided to the upper surface of the oil guiding member through the second liquid inlet holes of the sealing cover and the first liquid inlet holes of the oil guiding bracket, and then is absorbed by the oil guiding member and transmitted to the lower surface of the oil guiding member for atomization by the resistive heating element into smoke.

16. The atomizer of claim 15, wherein the atomizer further comprises a bottom bracket, the bottom bracket is arranged below the atomizing base, the bottom bracket comprises a bottom plate and a side wall extending upward from a periphery of the bottom plate, the bottom plate of the bottom bracket is provided with an air inlet hole, wherein external air enters the atomizer from the air inlet hole, carries the smoke generated by atomization to flow through the air outlet channel, the first air outlet hole, the second air outlet hole and the smoke outlet channel in sequence.

17. A manufacturing method of a heating assembly, comprising:
providing a resistive heating element, wherein the resistive heating element is in the form of a metal sheet, the resistive heating element comprises a heating fence, two connecting portions and two conductive pins arranged along a length direction of the resistive heating element, the heating fence is located in a middle of the resistive heating element, a plurality of through holes are provided through the heating fence, the two connecting portions are respectively located on two opposite sides of the heating fence and are interconnected by the heating fence, the two conductive pins are located at two opposite ends of the resistive heating element and are connected with the two connecting portions respectively;
placing the resistive heating element on a first mold, wherein the first mold is provided with a first molding groove and a first supporting platform surrounded by the first molding groove, the resistive heating element is arranged on the first supporting platform and at least partially extends to the first molding groove;
combining a second mold with the first mold, wherein the second mold is provided with a second molding groove and a second supporting platform located in the second molding groove, the heating fence is sandwiched between the first supporting platform and the second supporting platform;
injecting a molten material into the first molding groove and the second molding groove, wherein the molten material at least partially covers the resistive heating element, and the molten material after being solidified forms an atomizing base, the atomizing base and the resistive heating element are combined to form a heating assembly and the resistive heating element is at least partially embedded in the atomizing base, wherein the atomizing base comprises a base plate and a side wall extending from a periphery of the base plate, a receiving cavity is formed in the atomizing base and enclosed by the base plate and the side wall, an atomizing opening penetrates through the base plate, and the atomizing opening is aligned with the heating fence, wherein the first molding groove is configured for injection molding to form the side wall of the atomizing base, the second molding groove is configured for injection molding to form the base plate of the atomizing base, the first supporting platform is configured to form the receiving cavity in the atomizing base, and the second supporting platform is configured to form the atomizing opening in the base plate; and
separating the second mold from the first mold and taking out the heating assembly.

18. The manufacturing method of claim 17, wherein before injection molding, at least two resistive heating elements are connected to a connecting frame, the at least two resistive heating elements are connected to the connecting frame in parallel, and a distal end of each conductive pin far away from the heating fence is connected to the connecting frame; during injection molding, the resistive heating elements together with the connecting frame are placed on the first mold; after injection molding, the atomizing base is formed on each of the resistive heating elements.

19. The manufacturing method of claim 18, wherein the connecting frame and the at least two resistive heating elements connected thereto are formed integrally from a single metal sheet.

20. The manufacturing method of claim 18, wherein the connecting frame is a rectangular frame, the connecting frame comprises four connecting plates connected to each other to form a rectangle, a first crease groove is provided at a connection position between each conductive pin of the resistive heating element and the connecting frame, a second crease groove is provided at a connection position between two adjacent connecting plates, and the second crease groove is arranged in the same line with the first crease groove.

21. The manufacturing method of claim 18, wherein after injection molding, the heating assembly is separated from the connecting frame, the two conductive pins of the resistive heating element extend horizontally outwardly from both sides of the atomizing base, and each of the conductive pins is bent from an upper surface of the base plate of the atomizing base towards a lower surface of the base plate of the atomizing base, such that a distal end of each conductive pin far away from the heating fence is in contact with the lower surface of the base plate.

22. The manufacturing method of claim 17, wherein the first supporting platform comprises a first supporting surface facing the second mold, and the second supporting platform comprises a second supporting surface facing the first mold, an area of the first supporting surface is larger than an area of the second supporting surface; when the second mold is combined with the first mold, the second supporting platform is aligned with a middle portion of the first supporting platform, a vertical clearance between the first supporting surface and the second supporting surface is equal to a thickness of the resistive heating element, and the heating fence is sandwiched between the first supporting surface and the second supporting surface.

23. The manufacturing method of claim 22, wherein the first mold comprises a first connecting plane, the first molding groove is set on the first connecting plane, the second mold comprises a second connecting plane, the second molding groove is set on the second connecting plane, a height of the first supporting surface is lower than the first connecting plane, the second supporting surface and the second connecting plane are in the same plane; when the second mold is combined with the first mold, the first connecting plane and the second connecting plane are in contact with each other.

24. The manufacturing method of claim 17, wherein the first molding groove is an annular groove for injection molding to form the side wall of the atomizing base, the second molding groove comprises a groove side wall and a groove bottom wall, and the second supporting platform is formed at a central position of the groove bottom wall, an annular groove is formed between the groove side wall and a peripheral surface of the second supporting platform and configured for injection molding to form the base plate of the atomizing base.

25. The manufacturing method of claim 24, wherein the groove bottom wall is further provided with two cushion blocks, the two cushion blocks are located on two opposite sides of the second supporting platform respectively, one side of the cushion block is connected to the second supporting platform, and the other side of the cushion block away from the second supporting platform is located close to the groove side wall, a thickness of the cushion block gradually decreases from the second supporting platform towards the groove side wall; after injection molding to form the base plate, the base plate comprises two inclined portions due to the two cushion blocks, the two inclined portions are located at two opposite sides of the base plate along a width direction of the atomizing base, the atomizing opening is located between the two inclined portions, and a thickness of the inclined portion gradually decreases from the side wall to the atomizing opening.

26. The manufacturing method of claim 17, wherein each of the two connecting portions comprises an intermediate segment and two first embedding segments, the intermediate segment and two first embedding segments are arranged along a width direction of the resistive heating element, and the intermediate segment is connected between the two first embedding segments; after injection molding to form the atomizing base, a lower surface of the intermediate segment is embedded in the base plate, an upper surface of the intermediate segment is coplanar with an upper surface of the base plate and exposed to the receiving cavity, and the two first embedding segments are embedded in a connection position between the base plate and the side wall.

27. The manufacturing method of claim 26, wherein each of the two conductive pins is in the shape of an elongated structure and comprises a second embedding segment, a third embedding segment, a bending segment and an electrode segment, wherein the second embedding segment, the third embedding segment, the bending segment and the electrode segment are arranged along the length direction of the resistive heating element in sequence, the second embedding segment is connected to the intermediate segment of a corresponding connecting portion, the third embedding segment is connected between the second embedding segment and the bending segment, the bending segment is connected between the third embedding segment and the electrode segment; after injection molding to form the atomizing base, a lower surface of the second embedding segment is embedded in the base plate, an upper surface of the second embedding segment is coplanar with the upper surface of the base plate and exposed to the receiving cavity, the third embedding segment is embedded in a connection position between the base plate and the side wall, and the bending segment and the electrode segment extend horizontally outwardly from both sides of the atomizing base.

28. The manufacturing method of claim 27, wherein two embedding parts are provided at two opposite ends of the heating fence along the width direction of the resistive heating element, the heating fence is connected between the two embedding parts, each embedding part comprises a plurality of embedding legs which are spaced apart from each other along the length direction of the resistive heating element, each of the embedding legs comprises a fourth embedding segment and a fifth embedding segment, the fourth embedding segment is connected between the fifth embedding segment and the heating fence; after injection molding to form the atomizing base, a lower surface of the fourth embedding segment is embedded in the base plate, an upper surface of the fourth embedding segment is coplanar with the upper surface of the base plate and exposed to the receiving cavity, the fifth embedding segment is embedded in a connection position between the base plate and the side wall.

29. An assembly method of an atomizer, comprising:
providing the heating assembly of claim 1;
providing an oil guiding member and installing the oil guiding member in the receiving cavity, wherein the oil guiding member is in contact with the heating fence and the base plate.

30. The assembly method of claim 29, wherein the assembly method further comprises:
providing an oil guiding bracket, wherein the oil guiding bracket is provided with at least a first liquid inlet hole and a first air outlet hole, a lower end of the oil guiding bracket is provided with an annular pressing wall;
attaching the heating assembly to the lower end of the oil guiding bracket, such that the pressing wall extends into the receiving cavity and abuts against the oil guiding member, the first liquid inlet hole is communicated with the receiving cavity, and smoke oil can be transmitted to the oil guiding member through the first liquid inlet hole.

31. The assembly method of claim 30, wherein the assembly method further comprises:
providing a bottom bracket, wherein the bottom bracket comprises a bottom plate and a side wall extending upward from a periphery of the bottom plate, and the bottom plate is provided with an air inlet hole;
connecting the bottom bracket to the oil guiding bracket, such that the heating assembly is located between the oil guiding bracket and the bottom bracket, and the atomizing opening is located corresponding to the air inlet hole.

32. The assembly method of claim 31, wherein the assembly method further comprises:
providing a sealing cover, wherein the sealing cover is provided with at least a second liquid inlet hole and a second air outlet hole;
connecting the sealing cover to the oil guiding bracket to form an atomizing assembly, such that the second air outlet hole is communicated with the first air outlet hole, and the second liquid inlet hole is communicated with the first liquid inlet hole.

33. The assembly method of claim 32, wherein the assembly method further comprises:
providing an oil storage container, wherein the oil storage container is provided with an oil storage chamber and a smoke outlet channel therein, and a lower end of the oil storage container is an open end and is provided with an installation opening;
installing the atomizing assembly into the oil storage container from the installation opening, such that the oil storage chamber is communicated with the second liquid inlet hole, and the smoke outlet channel is communicated with the second air outlet hole;
wherein an air outlet channel is formed between an outer surface of the atomizing base and an inner surface of the oil storage container, an inner cavity of the bottom bracket is communicated with the air inlet hole, the air outlet channel communicates the inner cavity of the bottom bracket with the first air outlet hole.
